(19) United States
(12) Patent Application Publication
(10) Pub. No.: US 2013/0006844 A1
(43) Pub. Date: Jan. 3, 2013

(54) SYSTEMS AND METHODS FOR COLLATERALIZING LOANS

(75) Inventor: Gary Kremen, Menlo Park, CA (US)

(73) Assignee: Sociogramics, Inc., Menlo Park, CA (US)

(21) Appl. No.: 13/179,503

(22) Filed: Jul. 9, 2011

Related U.S. Application Data
(63) Continuation of application No. PCT/US11/42457, filed on Jun. 29, 2011.

(51) Int. Cl. G06Q 40/00

(52) U.S. Cl. 705/38; 705/35

(57) ABSTRACT

Systems and methods are disclosed for collateralizing loans. Some embodiments increase the likelihood of repayment by obtaining access to a qualified attribute of a borrower by a first computer component, monitoring by a second computer component for a financial event associated with the loan to the borrower, and taking control of the qualified attribute of the borrower by a third computer component. Taking control may include notifying social contacts. Securing the loan by taking various security interests and technical countermeasures against the borrower re-obtaining access or re-taking control are disclosed. Providing loans, receiving loan applications, providing loans proceeds, processing payments, and underwriting criteria are disclosed. Underwriting employing social contacts for recommendations, loan guarantees, social contact credit scores, public repayment promises, loan repayment coaches, fraud criteria, crowdsourced risk evaluation, social graphs, borrower stability factors derived from social graphs, data associated with online information repositories, and efficacy of notification are disclosed.

### CROSS-REFERENCE TO RELATED APPLICATIONS

This application is a continuation of PCT/US2011/042457, filed Jun. 29, 2011, entitled “Systems and Methods for Collaterizing Loans” and claims priority to U.S. patent application Ser. No. 13/114,979, filed May 24, 2011, entitled “Methods And Systems For Improving Timely Loan Repayment By Controlling Online Accounts, Notifying Social Contacts, Using Loan Repayment Coaches, Or Employing Social Graphs,” and to U.S. patent application Ser. No. 13/114,989, filed May 24, 2011, entitled “Methods And Systems For Improving Timely Loan Repayment By Controlling Online Accounts, Notifying Social Contacts, Using Loan Repayment Coaches, Or Employing Social Graphs,” both of which claim priority to U.S. Provisional Application No. 61/359,766, filed Jun. 29, 2010, entitled “Methods And Systems For Improving Timely Loan Repayment By Controlling Access To Online Social Networking And Related Accounts,” U.S. Provisional Application No. 61/436,523, filed Jan. 26, 2011, entitled “Methods And Systems For Improving Timely Loan Repayment By Controlling Borrower Online Social Networking And Related Accounts,” and U.S. Provisional Application No. 61/467,381, filed Mar. 25, 2011, entitled “Methods And Systems For Improving Timely Loan Repayment By Controlling Online Accounts Or Notifying Social Contacts,” all of which are incorporated by reference herein.

### FIELD OF THE INVENTION

Various embodiments of the present invention relate to methods and systems for increasing the likelihood of timely repayment of a loan. In particular, various embodiments of the present invention generally relate to systems and methods for collateralizing loans.

### BACKGROUND OF THE INVENTION

Lenders are in the business of loaning money to borrowers, such as individuals, companies and other entities. Lenders, in part, lend money based on what is known by those knowledgeable in the art as the “5 C's” of credit—collateral (assets to secure a loan), character (reputation, integrity or desire to repay the loan), capacity (sufficient cash flow to service the loan), capital (net worth), and conditions (of the borrower and the overall economy). The more or better the collateral, character, capacity, capital, and conditions, the more likely the loan and the lender will be repaid in a timely fashion.

Collateral is property or something of value that the lender can repossess or cause the sale of if the borrower defaults on the loan (e.g., the borrower fails to make timely payments as per the loan agreement or violates other conditions of the loan agreement). The loan may be secured by real, personal property, other “things of value.” Traditionally, real property, personal property (tangible or intangible), or other “things of value” act as collateral that may be repossessed or sold in the event of the borrower's default.

An alternative view of collateral is something of value to the borrower (which might not be of value to parties other than the borrower) in that repossessing or selling it will cause the borrower harm or distress. For example, certain items may have been “in the family” for a long time and are, thus, worth more to members of the family than an arm's length market value. Thus, the borrower will tend not to want that collateral repossessed or sold. An example of this alternative view is something of sentimental value to the borrower.

Character, in the context of lending, is the borrower's reputation, integrity or desire to repay the loan. A traditional stand-in for a borrower's character might be a credit score, such as a FICO® score.

Many individuals do not have collateral for loans or an easy way for a lender to obtain a stand-in for their character. Many businesses or entities similarly have difficulty providing a lender collateral or providing a suitable stand-in for their character. Examples of these borrowers might include those new to borrowing money, such as young people, the unbanked, the undocumented immigrant, new businesses, or those who have not made timely repayments of loans in the past. Because of these difficulties, lenders are less likely to lend to these borrowers, more likely to charge borrowers higher interest rates, or require stricter loan conditions. In short, the financial industry has virtually ignored these potential “less desirable” borrowers that do not satisfy traditional underwriting criteria. There are several companies that offer financing options to such borrowers, but their solutions are inadequate.

As such, new techniques are needed for assisting these individuals, businesses and other entities to acquire credit from lenders (so borrowers can more easily enter the mainstream of modern life) and for assisting lenders to increase their chances of receiving loan repayment, as well as reducing loan losses and increasing profits.

### SUMMARY OF THE INVENTION

The present teaching provides a wide variety of methods and systems for providing for the timely repayment of a loan. In one embodiment, a lender will obtain access to a borrower's qualified attribute, including a qualified online account and/or a borrower's qualified security authentication identification to ensure that the borrower complies with the loan conditions. The lender will monitor whether a financial event associated with the loan to the borrower has occurred and will take control of the borrower's qualified attribute upon the financial event. Taking control may include notifying the borrower's social contacts of the loan status. Securing the loan by taking various security interests are disclosed as are technical countermeasures against the borrower re-obtaining access or re-taking control. Also providing loans, receiving loan applications, providing loans proceeds, processing payments and underwriting criteria are disclosed. Underwriting employing social contacts for recommendations, loan guarantees, social contact credit scores, public repayment promises, loan repayment coaches, fraud criteria, crowdsourced risk evaluation, social graphs, borrower stability factors derived from social graphs, data associated with online information repositories, and efficacy of notification are disclosed.

A suitable qualified online account could be a repository of the borrower's social contacts, such as: Facebook®, LinkedIn®, Flickr®, Twitter®, Myspace®, Plaxo®, Match.com®, Second Life®, World of Warcraft®, Habbo Hotel®, Playdom®, Gaia Online®, as well as other social networks. In other embodiments, email accounts, such as Gmail® or Yahoo Mail® are also qualified online accounts. Additionally, qualified online accounts might be phones (or phone numbers), which might have an associated repository of social contacts, such as phone numbers called or texted by the borrower, or the phone numbers of those who called or texted the borrower (or the social contacts of these social contacts). Qualified online accounts could further be instant messaging accounts, such as ICQ® or AOL Instant Messenger®. Online gaming accounts, including multiplayer games, online gambling and online simulation environments are suitable in certain embodiments, as are accounts at dating services, product and company review sites, food and eating sharing sites, and health information sharing sites. Qualified online account also might include the combination of a borrower, a social network, data on the social network associated with the borrower, and credentials of the borrower to access the said data.

Qualified online accounts are held or hosted by a qualified online account service provider (also known as service providers), such as, but not limited to, Facebook, Inc., Google, Inc., or AT&T, Inc. These companies provide the relationship management service (e.g., LinkedIn), mail service (e.g., Gmail), phone services (e.g., AT&T®), or instant message services (e.g., ICQ or AOL Instant Messenger), respectively.

Qualified security authentication identification may include any protocols, codes, software, or other electronic mechanisms that are used to authenticate a borrower online. Examples of qualified security authentication identification could include uniform resource locators (URLs) and extensible resource identifier (XRIs) for OpenID®, extensible markup language (XML), security assertion markup language (SAML), protocols for JanRain®, and tokens for open authorization (OAuth).

Qualified security authentication providers are service providers that provide qualified security authentication identification. An example of a qualified security authentication provider is an OpenID provider. Examples of qualified security authentication service providers include Google, Inc., AOL®, Myspace, MyOpenID, Facebook Connect®, and Verisign®.

Qualified attributes are comprised of either the qualified online account(s) of the borrower, qualified authentication identification(s) of the borrower, or both.

Many individuals (companies or other entities) expend substantial time and resources creating and maintaining the repository of their social contacts for both personal and business reasons (i.e., for accumulating or connecting with their social contacts). The qualified online accounts as well as the qualified authentication identification which store these may be collateral that can be utilized by lenders to insure timely repayment of a loan by a borrower.

In accordance with an embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and securing the loan against the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and securing the loan against the qualified attribute of the borrower, wherein securing the loan includes filing a security interest financing statement for the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and securing the loan against the qualified attribute of the borrower, wherein securing the loan includes filing a security interest financing statement for qualified contents of the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and securing the loan against the qualified attribute, wherein securing the loan includes assigning, to a lender or third-party service provider, qualified contents of the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and securing the loan against the qualified attribute, wherein securing the loan includes assigning, to a lender or third-party service provider, qualified contents of the qualified attribute of the borrower, wherein assigning of the qualified contents is enforced by communicating a DMCA takedown notice upon the financial event.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event, wherein taking control includes taking technical countermeasures.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event, wherein taking control includes taking technical countermeasures, and wherein taking control includes restricting access of the borrower to the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event, wherein taking control includes taking technical countermeasures, and wherein taking control includes performing password changes to restrict access of the borrower to the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event, wherein taking control includes taking technical countermeasures, and wherein taking control includes instituting a proxy login via a proxy server for the borrower to access the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event, wherein the financial event includes a loan status that the borrower is in default of one or more loan conditions.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event, wherein the financial event includes a change of borrower status.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and applying underwriting criteria to the borrower to achieve a result.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; applying underwriting criteria to the borrower to achieve a result; and denying the loan based on the result of applying the underwriting criteria to the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; applying underwriting criteria to the borrower to achieve a result; and approving the loan based on the result of applying the underwriting criteria to the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and providing the loan to the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and providing the loan to the borrower, wherein providing the loan to the borrower includes providing loan proceeds via a qualified payment account of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and receiving a loan application from the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and processing loan payments from the borrower via a qualified payment account of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; and taking control of the qualified attribute of the borrower by a third computer component upon detection of the financial event, wherein taking control includes notifying at least one social contact of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event; and applying underwriting criteria to the borrower to achieve a result, wherein applying the underwriting criteria includes considering the efficacy of notification of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein at least some acts of the method are performed by a lender involved in the loan.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein at least some acts of the method are performed under control of a third-party service provider engaged by a lender involved in the loan.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein at least some acts of the method are performed under control of a third-party service provider engaged by a lender involved in the loan, and some acts of the method are performed by the lender.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the second computer component monitors for a plurality of financial events, and taking control includes various actions that depend upon a type of the financial event detected.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the financial event includes a substantial behavior change of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the financial event includes a substantial behavior change of the borrower, and wherein the substantial behavior change includes removing social contacts associated with a current employer of the borrower from the qualified attribute of the borrower.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the financial event includes a substantial behavior change of the borrower, and wherein the substantial behavior change includes a major drop in use of a qualified online service.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the financial event includes a substantial behavior change of the borrower, and wherein the substantial behavior change includes an incorporation of the borrower of apps designed to circumvent account or behavior monitoring.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the financial event includes a substantial behavior change of the borrower, and wherein the substantial behavior change includes lifestyle changes or unusual travel.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the financial event includes a substantial behavior change of the borrower, and wherein the substantial behavior change includes a change in a stability factor.

In accordance with another embodiment of the invention, a computer implemented method is disclosed for increasing the likelihood of timely repayment of a loan, the method comprising: obtaining access to a qualified attribute of a borrower by a first computer component; monitoring, by a second computer component, for a financial event associated with the loan to the borrower; taking control of the qualified attribute of the borrower by a third computer component upon detection of the financial event, wherein the borrower is married and the stability factor includes an evaluation of infidelity based on messaging between the married borrower and a non-spouse individual.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; and take control, via the network interface, of the qualified attribute of the borrower upon detection of the financial event.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and initiate a process to secure, the loan against the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and initiate a process to secure the loan against the qualified attribute of the borrower, including filing a security interest financing statement for the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and initiate a process to secure the loan against the qualified attribute of the borrower, including filing a security interest financing statement for qualified contents of the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and initiate a process to secure the loan against the qualified attribute of the borrower, including assigning to a lender qualified contents of the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon the financial event; and initiate a process to secure the loan against the qualified attribute of the borrower, including assigning qualified contents of the qualified attribute of the borrower, and wherein assigning to a lender the qualified contents of the qualified attribute of the borrower by the processor includes enforcement by communicating a DMCA takedown notice upon detection of the financial event.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; and take control, via the network interface, of the qualified attribute of the borrower upon detection the financial event, and wherein the memory is configured with further instructions, when executed, cause the process to take control, including taking technical countermeasures.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; and take control, via the network interface, of the qualified attribute of the borrower upon detection of the financial event, and wherein the memory is configured with further instructions, when executed, cause the process to take control, including taking technical countermeasures, including restricting access of the borrower to the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; and take control, via the network interface, of the qualified attribute of the borrower upon detection of the financial event, and wherein the memory is configured with further instructions, when executed, cause the process to take control, including taking technical countermeasures, including performing password changes to restrict access of the borrower to the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and wherein the memory is configured with further instructions, when executed, cause the process to take control, including institute, via the network interface, a proxy login via a proxy server for the borrower to access the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; and take control, via the network interface, of the qualified attribute of the borrower upon detection of the financial event, wherein the financial event includes a loan status that the borrower is in default of one or more loan conditions.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; and take control, via the network interface, of the qualified attribute of the borrower upon detection of the financial event, wherein the financial event includes a change of borrower status.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and initiate a process, via the network interface, for applying underwriting criteria to the borrower to achieve a result.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; initiate a process, via the network interface, for applying underwriting criteria to the borrower to achieve a result, and initiate a process for denying the loan based on the result of applying underwriting criteria to the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; initiate a process, via the network interface, for applying underwriting criteria to the borrower to achieve a result, and initiate a process for approving the loan based on the result of applying underwriting criteria to the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and initiate a process to provide, via the network interface, the loan to the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and initiate a process to provide, via the network interface, the loan to the borrower, including providing the loan proceeds via a qualified payment account of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and receive, via the network interface, a loan application from the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; and process, via the network interface, loan payments from the borrower via a qualified payment account of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; and take control, via the network interface, of the qualified attribute of the borrower upon detection of the financial event, including notifying, via the network interface, at least one social contact of the borrower, a loan status of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; initiate a process, via the network interface, for applying underwriting criteria to the borrower to achieve a result, including considering the efficacy of notification of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; wherein the system is a lender's computer system.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; wherein the system is a third-party service provider's computer system, and the third-party service provider is engaged by a lender in connection with the loan.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event; wherein the system is a distributed system, and one or both of the memory and the processor can each be multiple distinct devices located on separate computer systems.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection the financial event, wherein the system monitors via the network interface for a plurality of financial events, and taking control includes various actions that depend upon a type of the financial event detected.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event, wherein the financial event includes a substantial behavior change of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event, wherein the financial event includes a substantial behavior change of the borrower, and wherein the substantial behavior change includes removing social contacts associated with a current employer of the borrower from the qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event, wherein the financial event includes a substantial behavior change of the borrower and wherein the substantial behavior change includes a major drop in use of a qualified online service.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event, wherein the financial event includes a substantial behavior change of the borrower, and wherein the substantial behavior change includes an incorporation of the borrower of apps designed to circumvent account or behavior monitoring.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event, wherein the financial event includes a substantial behavior change of the borrower, and wherein the substantial behavior change includes lifestyle changes or unusual travel.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event, wherein the financial event includes a substantial behavior change of the borrower, and wherein the substantial behavior change includes a change in a stability factor.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; monitor, via the network interface, for a financial event associated with the loan to the borrower; take control, via the network interface, of the qualified attribute of the borrower upon detection of the financial event, wherein the financial event includes a substantial behavior change of the borrower, wherein the substantial behavior change includes a change in a stability factor, and wherein the borrower is married and the stability factor includes an evaluation of infidelity based on messaging between the married borrower and a non-spouse individual.

In accordance with another embodiment of the invention, a computer implemented method for increasing the likelihood of timely repayment of a loan, the method comprising: obtaining access to a Facebook account of a borrower on the loan by a first computer component; monitoring by a second computer component for a financial event associated with the loan to the borrower; and taking control of the Facebook account of the borrower by a third computer component upon detection of the financial event, including notifying at least one friend of the borrower of a loan status of the borrower.

In accordance with another embodiment of the invention, a computer implemented method for increasing the likelihood of timely repayment of a loan, the method comprising: obtaining access to a Facebook account of a borrower on the loan by a first computer component; monitoring by a second computer component for a financial event associated with the loan to the borrower; and taking control of the Facebook account of the borrower by a third computer component upon detection of the financial event, including notifying at least one friend of the borrower of a loan status of the borrower, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a Facebook account of a borrower on the loan; monitor, via the network interface, for a financial event associated with the loan to the borrower; and take control, via the network interface, of the Facebook account of the borrower upon detection of the financial event, including notifying at least one friend of the borrower of a loan status of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a Facebook account of a borrower on the loan; monitor, via the network interface, for a financial event associated with the loan to the borrower; and take control, via the network interface, of the Facebook account of the borrower upon detection of the financial event, including notifying at least one friend of the borrower of a loan status of the borrower, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a computer implemented method for increasing the likelihood of timely repayment of a loan by a borrower, the method comprising: obtaining access to an email account of the borrower by a first computer component; monitoring by a second computer component for a financial event associated with the loan to the borrower; and taking control of the email account of the borrower by a third computer component upon the financial event, wherein taking control includes changing the password of the email account of the borrower.

In accordance with another embodiment of the invention, a computer implemented method for increasing the likelihood of timely repayment of a loan by a borrower, the method comprising: obtaining access to an email account of the borrower by a first computer component; monitoring by a second computer component for a financial event associated with the loan to the borrower; and taking control of the email account of the borrower by a third computer component upon the financial event, wherein taking control includes changing the password of the email account of the borrower, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a system for increasing the likelihood of timely repayment of a loan by a borrower, the system comprising: a network interface; a processor; and a memory, wherein the memory is configured with instructions which, when executed, cause the processor to: obtain access, via the network interface, to an email account of the borrower; monitor, via the network interface, for a financial event associated with the loan to the borrower; and take control, via the network interface, of the email account of the borrower upon detection of the financial event, wherein to take control includes changing the password of the email account of the borrower.

In accordance with another embodiment of the invention, a system for increasing the likelihood of timely repayment of a loan by a borrower, the system comprising: a network interface; a processor; and a memory, wherein the memory is configured with instructions which, when executed, cause the processor to: obtain access, via the network interface, to an email account of the borrower; monitor, via the network interface, for a financial event associated with the loan to the borrower; and take control, via the network interface, of the email account of the borrower upon detection of the financial event, wherein to take control includes changing the password of the email account of the borrower, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a computer implemented method for increasing the likelihood of timely repayment of a loan by a borrower, the method comprising: obtaining access to a Facebook account of the borrower by a first computer component; monitoring by a second computer component for a financial event associated with the loan to the borrower; and taking control of the Facebook account of the borrower by a third computer component upon detection of the financial event, wherein taking control includes assigning qualified content of the Facebook account of the borrower to the lender.

In accordance with another embodiment of the invention, a computer implemented method for increasing the likelihood of timely repayment of a loan by a borrower, the method comprising: obtaining access to a Facebook account of the borrower by a first computer component; monitoring by a second computer component for a financial event associated with the loan to the borrower; and taking control of the Facebook account of the borrower by a third computer component upon detection of the financial event, wherein taking control includes assigning qualified content of the Facebook account of the borrower to the lender, and wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a system for increasing the likelihood of timely repayment of a loan by a borrower, the system comprising: a network interface; a processor; and a memory, wherein the memory is configured with instructions which, when executed, cause the processor to: obtain access, via the network interface, to a Facebook account of the borrower; monitor, via the network interface, for a financial event associated with the loan to the borrower; and take control, via the network interface, of the Facebook account of the borrower upon detection of the financial event, wherein to take control includes assigning qualified content of the Facebook account of the borrower to the lender.

In accordance with another embodiment of the invention, a system for increasing the likelihood of timely repayment of a loan by a borrower, the system comprising: a network interface; a processor; and a memory, wherein the memory is configured with instructions which, when executed, cause the processor to: obtain access, via the network interface, to a Facebook account of the borrower; monitor, via the network interface, for a financial event associated with the loan to the borrower; and take control, via the network interface, of the Facebook account of the borrower upon detection of the financial event, wherein to take control includes assigning qualified content of the Facebook account of the borrower to the lender, and wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a computer implemented method for increasing the likelihood of timely repayment of a loan by a borrower, the method comprising: obtaining access to a Facebook account of the borrower by a first computer component; monitoring by a second computer component for a financial event associated with the loan to the borrower; taking control of the Facebook account of the borrower by a third computer component upon detection of the financial event, wherein taking control includes assigning qualified content of the Facebook account of the borrower to the lender; and enforcing the assignment by communicating a DMCA takedown notice upon the financial event.

In accordance with another embodiment of the invention, a computer implemented method for increasing the likelihood of timely repayment of a loan by a borrower, the method comprising: obtaining access to a Facebook account of the borrower by a first computer component; monitoring by a second computer component for a financial event associated with the loan to the borrower; taking control of the Facebook account of the borrower by a third computer component upon detection of the financial event, wherein taking control includes assigning qualified content of the Facebook account of the borrower to the lender; and enforcing the assignment by communicating a DMCA takedown notice upon the financial event, and wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a system for increasing the likelihood of timely repayment of a loan by a borrower, the system comprising: a network interface; a processor; and a memory, wherein the memory is configured with instructions which, when executed, cause the processor to: obtain access, via the network interface, to a Facebook account of the borrower by a first computer component; monitor, via the network interface, for a financial event associated with the loan to the borrower; take control, via the network interface, of the Facebook account of the borrower upon detection of the financial event, wherein to take control includes assigning qualified content of the Facebook account of the borrower to the lender; and enforcing the assignment by communicating a DMCA takedown notice upon detection of the financial event.

In accordance with another embodiment of the invention, a system for increasing the likelihood of timely repayment of a loan by a borrower, the system comprising: a network interface; a processor; and a memory, wherein the memory is configured with instructions which, when executed, cause the processor to: obtain access, via the network interface, to a Facebook account of the borrower by a first computer component; monitor, via the network interface, for a financial event associated with the loan to the borrower; take control, via the network interface, of the Facebook account of the borrower upon detection of the financial event, wherein to take control includes assigning qualified content of the Facebook account of the borrower to the lender; and enforcing the assignment by communicating a DMCA takedown notice upon detection of the financial event, and wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a computer implemented method for increasing the likelihood of timely repayment of a loan, the method comprising: obtaining access to a Facebook account of a borrower on the loan by a first computer component; monitoring by a second computer component for a financial event associated with the loan to the borrower; and notifying social contacts of the Facebook account of the borrower by a third computer component upon detection of the financial event, whereby notifying social contacts includes notifying by a Facebook message, creating a Facebook event, or posting on a Facebook wall of the borrower.

In accordance with another embodiment of the invention, a computer implemented method for increasing the likelihood of timely repayment of a loan, the method comprising: obtaining access to a Facebook account of a borrower on the loan by a first computer component; monitoring by a second computer component for a financial event associated with the loan to the borrower; and notifying social contacts of the Facebook account of the borrower by a third computer component upon detection of the financial event, whereby notifying social contacts includes notifying by a Facebook message, creating a Facebook event, or posting on a Facebook wall of the borrower, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a system for increasing the likelihood of timely repayment of a loan, the system comprising: a network interface; a processor; and a memory, wherein the memory is configured with instructions which, when executed, cause the processor to: obtain, via the network interface, access to a Facebook account of a borrower on the loan; monitor, via the network interface, for a financial event associated with the loan to the borrower; and notify, via the network interface, social contacts of the Facebook account of the borrower upon detection of the financial event, whereby to notify social contacts includes notifying by a Facebook message, creating a Facebook event, or posting on a Facebook wall of the borrower.

In accordance with another embodiment of the invention, a computer implemented method for increasing the likelihood of timely repayment of a loan, the method comprising: obtaining access to a Facebook account of a borrower on the loan by a first computer component; monitoring by a second computer component for a financial event associated with the loan to the borrower; and notifying social contacts of the Facebook account of the borrower by a third computer component upon detection of the financial event, whereby notifying social contacts includes notifying by a Facebook message, creating a Facebook event, or posting on a Facebook wall of the borrower, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a computer implemented method for increasing the likelihood of timely repayment of a loan, the method comprising: obtaining access to a Facebook account of a borrower on the loan by a first computer component; applying underwriting criteria including requiring the borrower to take on a loan repayment coach by a second computer component; monitoring by a third computer component for a financial event associated with the loan to the borrower; and notifying the loan repayment coach by a fourth computer component upon detection of the financial event.

In accordance with another embodiment of the invention, a computer implemented method for increasing the likelihood of timely repayment of a loan, the method comprising: obtaining access to a Facebook account of a borrower on the loan by a first computer component; applying underwriting criteria including requiring the borrower to take on a loan repayment coach by a second computer component; monitoring by a third computer component for a financial event associated with the loan to the borrower; and notifying the loan repayment coach by a fourth computer component upon detection of the financial event, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a Facebook account of a borrower on the loan; apply underwriting criteria, using the processor, including requiring the borrower to take on a loan repayment coach; monitor, via the network interface, for a financial event associated with the loan to the borrower; and notify, via the network interface, the loan repayment coach upon detection of the financial event.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a Facebook account of a borrower on the loan; apply underwriting criteria, using the processor, including requiring the borrower to take on a loan repayment coach; monitor, via the network interface, for a financial event associated with the loan to the borrower; and notify, via the network interface, the loan repayment coach upon detection of the financial event, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a computer implemented method for increasing the likelihood of timely repayment of a loan, the method comprising: obtaining access to a Facebook account of the borrower by a first computer component; applying underwriting criteria including requiring the borrower to take on a loan repayment coach by a second computer component; monitoring by a third computer component for a financial event associated with the loan to the borrower; and notifying the borrower of comments of the loan repayment coaches by a fourth computer component upon detection of the financial event.

In accordance with another embodiment of the invention, a computer implemented method for increasing the likelihood of timely repayment of a loan, the method comprising: obtaining access to a Facebook account of the borrower by a first computer component; applying underwriting criteria including requiring the borrower to take on a loan repayment coach by a second computer component; monitoring by a third computer component for a financial event associated with the loan to the borrower; and notifying the borrower of comments of the loan repayment coaches by a fourth computer component upon detection of the financial event, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a Facebook account of the borrower; apply underwriting criteria, using the processor, including requiring the borrower to take on a loan repayment coach; monitor, via the network interface, for a financial event associated with the loan to the borrower; and notify, via the network interface, the borrower of comments of the loan repayment coaches upon detection of the financial event.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a Facebook account of the borrower; apply underwriting criteria, using the processor, including requiring the borrower to take on a loan repayment coach; monitor, via the network interface, for a financial event associated with the loan to the borrower; and notify, via the network interface, the borrower of comments of the loan repayment coaches upon detection of the financial event, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

In accordance with another embodiment of the invention, a computer implemented method is disclosed for increasing the likelihood of timely repayment of a loan, the method comprising: applying underwriting criteria for a borrower by a first computer component, wherein the underwriting criteria includes at least one consideration related to a qualified attribute of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering one or more recommendations of one or more social contacts of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering a loan guarantee by one or more social contacts of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering a social contact credit score of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering a public repayment promise of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering one or more loan repayment coaches of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering fraud criteria.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering a crowdsourced risk evaluation.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria includes considering a social graph of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; wherein applying underwriting criteria including considering a stability factor derived from the social graph of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; and wherein applying underwriting criteria includes considering data associated with the borrower from an online information repository.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; and wherein applying underwriting criteria includes considering the efficacy of notification of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; and providing the loan to the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; and providing the loan to the borrower, wherein providing the loan includes providing loan proceeds via a qualified payment account of the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; and receiving a loan application from the borrower.

In accordance with another embodiment of the invention, a computer implemented method is disclosed for increasing the likelihood of timely repayment of a loan, the method comprising: applying underwriting criteria for the borrower by a first computer component, wherein the underwriting criteria includes at least one consideration related to a qualified attribute of the borrower; and processing loan payments from the borrower via a qualified payment account of the borrower.

In accordance with another embodiment of the invention, a computer implemented method is disclosed for increasing the likelihood of timely repayment of a loan, the method comprising: receiving a set of underwriting considerations of a borrower; and applying underwriting criteria for the borrower by a first computer component, wherein the underwriting criteria includes at least one consideration related to a qualified attribute of the borrower.

In accordance with another embodiment of the invention, a computer implemented method is disclosed for increasing the likelihood of timely repayment of a loan, the method comprising: receiving a set of underwriting considerations of a borrower; and applying underwriting criteria for the borrower by a first computer component, wherein the underwriting criteria includes at least one consideration related to a qualified attribute of the borrower, wherein the at least one consideration includes one or more of: a crowdsourced risk evaluation, a privacy setting of a qualified online account, an efficacy of notification, a social contact credit score, or one or more recommendations from one or more social contacts.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower, wherein the system is a lender's computer system.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower, wherein the system is a third-party service provider's computer system, and the third-party service provider is engaged by a lender in connection with the loan.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower, wherein the system is a distributed system and one or both of the memory and the processor can each be multiple distinct devices located on separate computer systems.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering one or more recommendations of one or more social contacts of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering a loan guarantee by one or more social contacts of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering a social contact credit score of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering a public repayment promise of the borrower.

In accordance with another embodiment of the invention, a lender's system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering a loan repayment coach of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering fraud criteria.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering a crowdsourced risk evaluation of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering a social graph of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering a stability factor derived from the social graph of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering data from online information repositories.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; and apply, via the network interface, underwriting criteria for the borrower including considering the efficacy of notification of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; apply, via the network interface, underwriting criteria for the borrower; and provide the loan to the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; apply, via the network interface, underwriting criteria for the borrower; and provide the loan to the borrower including providing the loan proceeds via a qualified payment account of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; apply, via the network interface, underwriting criteria for the borrower; and receive a loan application from the borrower.

In accordance with another embodiment of the invention, a system for increasing the likelihood of timely repayment of a loan, the system comprising: a network interface; a processor; and a memory, wherein the memory is configured with instructions which, when executed, cause the processor to: obtain access, via the network interface, to a qualified attribute of a borrower; apply, via the network interface, underwriting criteria for the borrower; and process loan payments from the borrower via a qualified payment account of the borrower.

In accordance with another embodiment of the invention, a computer implemented method for increasing the likelihood of timely repayment of a loan to a borrower, the method comprising: obtaining access to a Facebook Graph API of the borrower by a first computer component; applying underwriting criteria to the borrower considering the Facebook Graph API by a second computer component; and receiving a loan application from the borrower by a third computer component.

In accordance with another embodiment of the invention, a system for increasing the likelihood of timely repayment of a loan to a borrower, the system comprising: a network interface; a processor; and a memory, wherein the memory is configured with instructions which, when executed, cause the processor to: obtain access, via the network interface, to a Facebook Graph API of the borrower; apply underwriting criteria, using the processor, to the borrower considering the Facebook Graph API; and receive, via the network interface, a loan application from the borrower.

In accordance with another embodiment of the invention, a computer implemented method for increasing the likelihood of timely repayment of a loan to a borrower, the method comprising: obtaining access to a social graph of the borrower derived from LinkedIn by a first computer component; and applying underwriting criteria to the social graph of the borrower derived from LinkedIn by a second computer component; and receiving a loan application from the borrower by a third computer component.

In accordance with another embodiment of the invention, a system for increasing the likelihood of timely repayment of a loan to a borrower, the system comprising: a network interface; a processor; and a memory, wherein the memory is configured with instructions which, when executed, cause the processor to: obtain access, via the network interface, to a social graph of the borrower derived from LinkedIn; and apply underwriting criteria, using the processor, to the social graph of the borrower derived from LinkedIn; and receive, via the network interface, a loan application from the borrower.

In accordance with another embodiment of the invention, a computer implemented method for increasing the likelihood of timely repayment of a loan to a borrower, the method comprising: obtaining access to a social graph of the borrower by a first computer component; and applying underwriting criteria to the borrower considering a stability factor derived from the social graph of the borrower by a second computer component; and receiving a loan application from the borrower by a third computer component.

In accordance with another embodiment of the invention, a system for increasing the likelihood of timely repayment of a loan to a borrower, the system comprising: a network interface; a processor; and a memory, wherein the memory is configured with instructions which, when executed, cause the processor to: obtain access, via the network interface, to a social graph of the borrower; and apply underwriting criteria, using the processor, to the borrower considering a stability factor derived from the social graph of the borrower; and receive, via the network interface, a loan application from the borrower.

In accordance with another embodiment of the invention, a computer implemented method for increasing the likelihood of timely repayment of a loan to a borrower, the method comprising: obtaining access to a social graph of the borrower by a first computer component; and applying underwriting criteria to the borrower considering a relationship stability factor derived from the social graph of the borrower by a second computer component; and receiving a loan application from the borrower by a third computer component.

In accordance with another embodiment of the invention, a system for increasing the likelihood of timely repayment of a loan to a borrower, the system comprising: a network interface; a processor; and a memory, wherein the memory is configured with instructions which, when executed, cause the processor to: obtain access, via the network interface, to a social graph of the borrower; and apply underwriting criteria, using the processor, to the borrower considering a relationship stability factor derived from the social graph of the borrower; and receive, via the network interface, a loan application from the borrower.

In accordance with another embodiment of the invention, a computer implemented method for increasing the likelihood of timely repayment of a loan to a borrower, the method comprising: obtaining access to a social graph of the borrower by a first computer component; and applying underwriting criteria to the borrower considering an employment stability factor derived from the social graph of the borrower by a second computer component; and receiving a loan application from the borrower by a third computer component.

In accordance with another embodiment of the invention, a system for increasing the likelihood of timely repayment of a loan to a borrower, the system comprising: a network interface; a processor; and a memory, wherein the memory is configured with instructions which, when executed, cause the processor to: obtain access, via the network interface, to a social graph of the borrower; and apply underwriting criteria, using the processor, to the borrower considering an employment stability factor derived from the social graph of the borrower; and receive, via the network interface, a loan application from the borrower.

In accordance with another embodiment of the invention, a system for increasing the likelihood of timely repayment of a loan, the system comprising: a network interface; a processor; and a memory, wherein the memory is configured with instructions which, when executed, cause the processor to: receive, via the network interface, a set of underwriting considerations of a borrower; and apply, using the processor, underwriting criteria for the borrower by a first computer component, wherein the underwriting criteria includes at least one consideration related to a qualified attribute of the borrower.

In accordance with another embodiment of the invention, a system for increasing the likelihood of timely repayment of a loan, the system comprising: a network interface; a processor; and a memory, wherein the memory is configured with instructions which, when executed, cause the processor to: receive, via the network interface, a set of underwriting considerations of a borrower; and apply, using the processor, underwriting criteria for the borrower by a first computer component, wherein the underwriting criteria includes at least one consideration related to a qualified attribute of the borrower, wherein the at least one consideration includes a crowdsourced risk evaluation, a privacy setting of a qualified online account, an efficacy of notification, a social contact credit score, or one or more recommendations from one or more social contacts.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the summary, drawings, and detailed description are to be regarded as illustrative in nature and not restrictive.

### BRIEF DESCRIPTION OF THE DRAWINGS

The accompanying drawings, which are incorporated herein, constitute a part of the specification, illustrate embodiments of the invention and, together with the general description given above and the detailed description of the embodiments, serve to explain the principles of the invention.

FIG. 1 is a flowchart illustrating a method in accordance with embodiments of the present teaching.

FIG. 2 is a flowchart illustrating a method in accordance with one aspect of the present teaching.

FIGS. 2A and 2B illustrate block diagrams of the network relationships of computer systems (e.g., lender, borrower, and qualified online account service provider, respectively), for implementation of certain embodiments.

FIG. 3 illustrates a network diagram according to certain aspects of the present teaching.

FIG. 4 is a flowchart illustrating another embodiment.

FIG. 5 illustrates a network diagram according to other aspects of the present teaching.

FIG. 6 is a flowchart illustrating yet another embodiment.

FIG. 7 is a network diagram for a further embodiment.

FIG. 8 is a flowchart illustrating an aspect of the present teaching.

FIG. 9 is one possible computer system for use with the present teaching.

FIG. 10 is an underwriting flow diagram in accordance with some embodiments of the present invention.

FIG. 11 is a flowchart illustrating the underwriting and approval process in accordance with the embodiments of the present invention.

### DETAILED DESCRIPTION OF THE INVENTION

Note that many of the terms used in the specification are defined at the end of this specification under “Terms and Definitions” and control in this application. (If any inconsistency arises between this application and the prior provisional applications identified above, the present teaching should be interpreted to cover the present disclosure and the disclosure of the prior provisional applications incorporated herein).

Many actual or potential borrowers have unrealized assets that can be used as collateral: these are termed “qualified attributes of a borrower.” Qualified attributes may be the qualified online account(s) of the borrower, qualified authentication identification(s) of the borrower, or a suitable combination of both.

A qualified online account can be a repository of the borrower's social contacts, such as: Facebook, LinkedIn, Flickr, Twitter, Myspace, Plaxo, Match.com, Second Life, World of Warcraft, Habbo Hotel, Playdom, Gaia Online, as well as other social networks (additionally defined later). An email account, such as Gmail or Yahoo Mail, could also be a qualified online account. Additionally, qualified online accounts might include phones (or phone numbers), which might have an associated repository of social contacts, such as phone numbers called or texted by the borrower, or the phone numbers of those who called or texted the borrower (or the social contacts of these social contacts). Qualified online accounts could also be instant messaging accounts, such as ICQ or AOL Instant Messenger. Online gaming accounts, including multiplayer games, online gambling, and online simulation environments are specifically thought of as being suitable qualified online accounts, as are accounts at dating services, product and company review sites, food and eating sharing sites, and health information sharing sites. Qualified online account also might include the combination of a borrower, a social network, data on the social network associated with the borrower, and credentials of the borrower to access the said data.

Qualified security authentication identification can be any protocols, codes, software, or other electronic mechanisms that are used to authenticate a borrower online. Examples of qualified security authentication identification could include uniform resource locators (URLs) and extensible resource identifier (XRIs) for OpenID, extensible markup language (XML), security assertion markup language (SAML), protocols for JanRain, and tokens for open authorization (OAuth).

Lenders or a third-party lender service provider can work with potential borrowers and service (account) providers, such as these, to facilitate the provisioning of credit to the potential borrowers by incorporating qualified attributes into the lending model, as discussed in detail below.

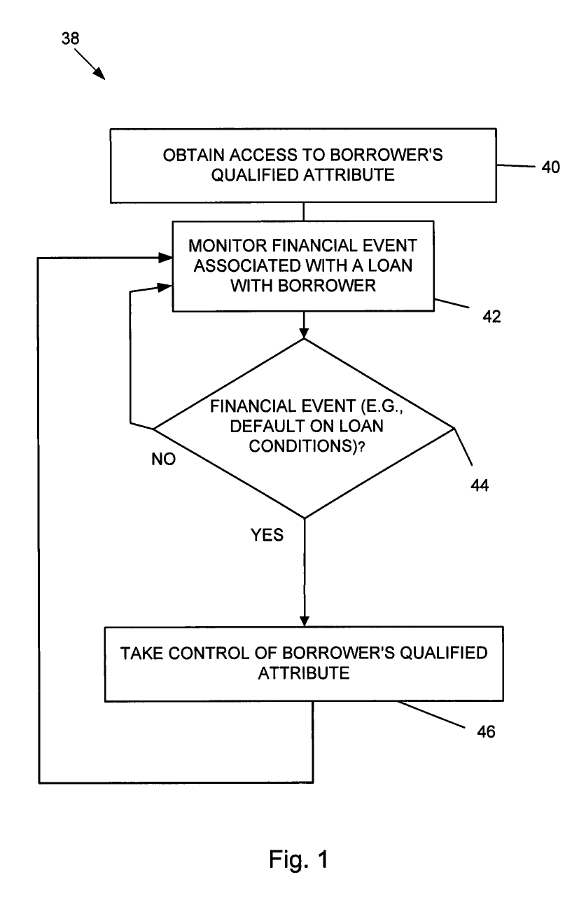

FIG. 1 is a flowchart illustrating certain steps of a method 38 in accordance with embodiments of the present invention. In method 38, execution begins at step 40 wherein a lender obtains access to a borrower's qualified attribute. Obtaining access to a borrower's qualified attribute can include obtaining, and perhaps even taking control over, the borrower's qualified security identification for the relevant qualified attribute.

The method 38 continues in step 42 wherein the loan is monitored for one or more financial events. The financial event might correspond to events specifically related to details of the loan, such as timely payment, default, late payment, etc. In some embodiments, the loan may be monitored for events, such as a change in borrower status (e.g., recently moved, divorced), or a change in the qualified attribute. Execution then moves to decision diamond 44 wherein it is determined if a financial event has occurred. If no financial event has occurred, execution returns to step 42 where the method 38 continues monitoring the loan.

Continuing on with the method 38, if a financial event has been detected, then execution moves step 46 wherein the lender takes a specific action in response to the detected financial event. In the extreme case, step 46 corresponds to taking control of the borrower's qualified attribute. Taking control may include restricting access to the qualified attribute, notifying social contacts of the qualified attribute, or any other action as described in this application. In other instances, step 46 may correspond to an action internal to the lender or third-party service provider, such as updating records related to the borrower, or increasing the scrutiny on the borrower's performance on the loan due to some change in borrower status which may reflect a decrease in likelihood of loan repayment. Subsequent to step 46, the method 38 may return to step 42 to continue monitoring the loan.

As indicated, FIG. 1 illustrates certain high level steps of the method. However, those skilled in the art will appreciate that other steps may be employed to generate desired results. For example, certain initialization steps can be performed prior to step 40. In certain embodiments, the method 38 is performed by a lender. In other embodiments, the method 38 is performed by a third-party providing a service to a lender. In further embodiments, certain steps of the method 38 are performed by a lender, while other steps are performed by a third-party service provider.

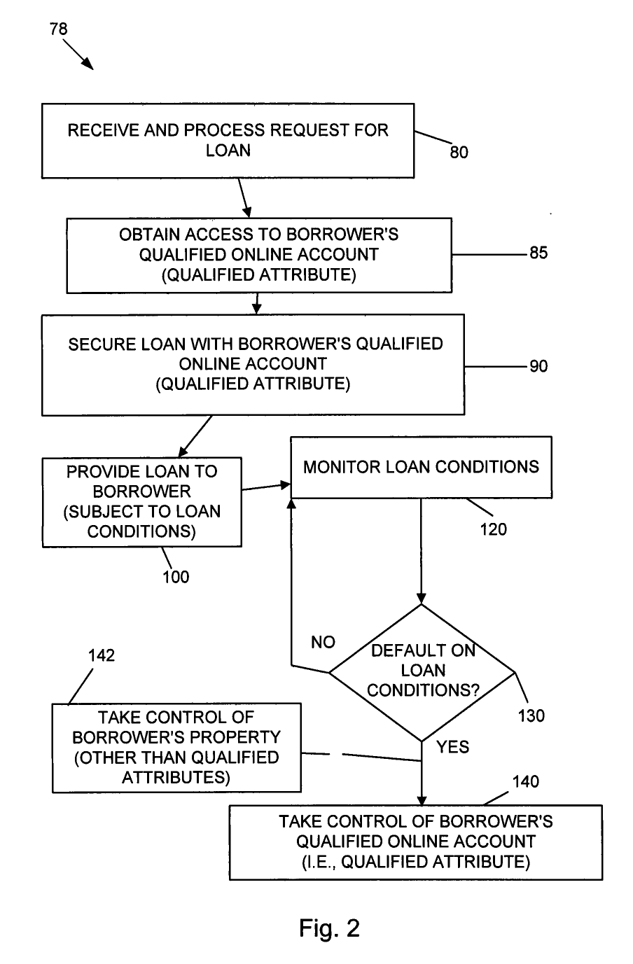

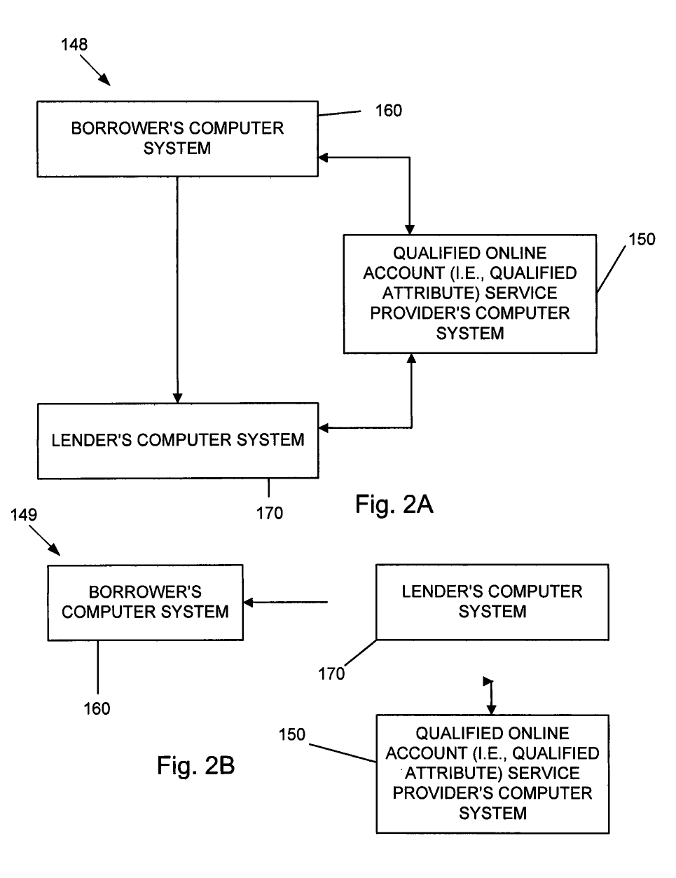

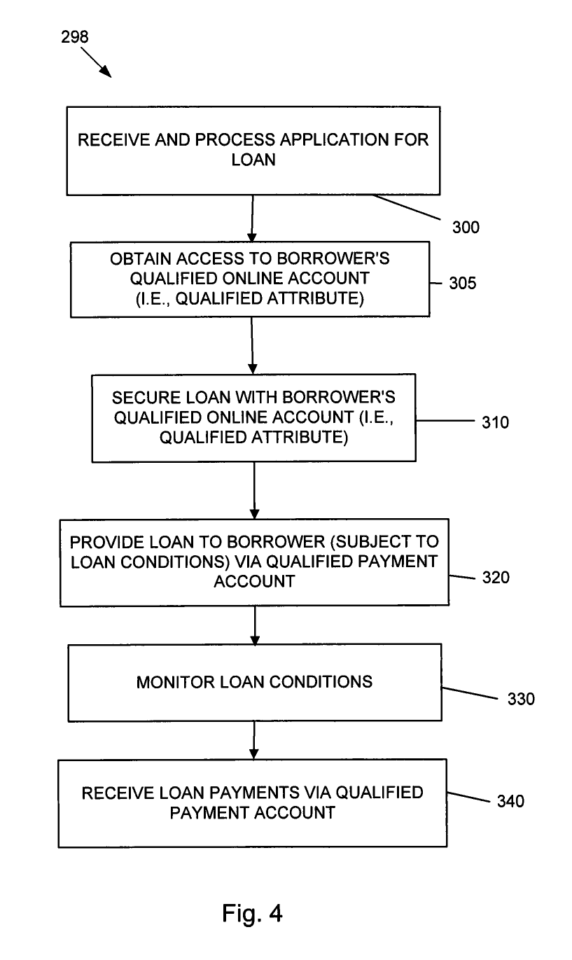

FIG. 2 is a flowchart illustrating steps of a method 78 according to another aspect of the present teaching. FIGS. 4, 6, and 8 illustrate other embodiments, i.e., detailed implementations as discussed below, and those skilled in the art know, after reading this disclosure, that other implementations, i.e., variations, additions, and deletions of the steps, of the method exist in accordance with the present invention.

The method 78 of FIG. 2 begins when a lender receives and processes a loan application or request for a loan by a borrower at step 80. This could be done through an application or app (e.g., a Facebook application, a LinkedIn application, an iPhone® app, an Application Program Interface (API), an http request, a web server, a Remote Procedure Call (RPC), a Uniform Data Packet request (UDP), a Representable State Transfer (REST), a Simple Object Access Protocol (SOAP), etc.), directly by the lender, or indirectly by another loan provider (including incorporating a third-party (1) who is an originator of a loan, such as PayPal® or a Chase® credit card, for example, and/or (2) who provides for a loan, such as a loan broker or an affiliate relationship). Step 80 could be done electronically, by paper application, orally, etc. As part of the loan process, and subsequent agreement (written, electronic, or oral) between the lender and borrower, the lender will require, and the borrower will agree, to adhere to certain loan conditions, such as the following:

(1) to offer access (including ability to change account information) to the borrower's qualified online account(s), i.e., as collateral, or the ability to notify social contacts (or the borrower's qualified security authentication identification as described in detail below, or other qualified attribute of the borrower). As indicated above, the qualified online account may represent one or more of the borrower's Facebook, LinkedIn, Flickr, Twitter, Myspace, Match.com, Second Life, World of Warcraft, or any other social networking site account(s), or email account(s), such as Gmail or Yahoo Mail, or other repository of social contacts, such as phone number, texting, or instant message log(s). Qualified online accounts might be represented as the phone (or phone number(s)) of the borrower with social contacts of the borrower, in this case being social contacts that call or text the borrower, or social contacts that the borrower calls or texts. Access or use of a qualified online account may be made by an application or app (as defined in Terms and Definitions below) that interfaces with a qualified online account, such as: a Facebook application, a LinkedIn application, an iPhone app, an Application Program Interface (API), an http request, a web server, a Remote Procedure Call (RPC), a Uniform Data Packet request (UDP), a Representable State Transfer (REST), a Simple Object Access Protocol (SOAP), etc. Access may be achieved directly via a computer system or via a mobile device (e.g., Blackberry, iPhone, Android, etc.) or other electronic mechanism. The borrower may offer access to another qualified attribute, such as a qualified security authentication identification as described in more detail below;

(2) to provide the borrower's qualified online account information including, but not limited to, the borrower's login name, password, access to any secret questions used for authentication, etc.;

(3) that borrower will not change (in certain embodiments) qualified online account information, such as: login name, password, access to any secret questions used for authentication, etc., until the borrower has complied with all loan conditions (e.g., repaid the loan in full in a timely manner), or will get permission to make any changes from the lender, but advise the lender of any and all other changes to the borrower's qualified online account information (or other qualified attributes as described below);

(4) authorize the lender to periodically login (in certain embodiments) to the borrower's qualified online account to ensure that the lender has continuing access (including ability to change account information);

(5) authorize the lender to evaluate the information of the borrower's qualified online account (or other qualified attribute) to determine efficacy of notification, i.e., whether the borrower will be affected by public exposure relating to the status of the loan;

(6) authorize the lender to take control of the borrower's qualified online account (or other qualified attributes as described in detail below) including, for example, authorization for performing password changes (restricting access to qualified online account), notifying social contacts of the borrower that the borrower is, or is not, in default of the loan conditions, and/or for instituting a DMCA take down notice. Social contacts include any person, company, or other entity, that the borrower has a relationship with that is tracked by a borrower's qualified online account (or other qualified attribute). Social contacts are sometimes known as “friends” (in the case of Facebook), “network members” (in the case of LinkedIn), “email contacts” (in the case of email), “phone contacts” (in the case of phone calls), “buddies” or “contacts” (in the case of instant messaging), or other similar terms. Additionally, social contacts might be people or entities called or texted by the borrower, or who call or text the borrower. Social contacts are the primary components of the social graph of the borrower. The social graph is the relationship mapping of the social contacts of the borrower, and how they relate. For example, in Facebook, the Graph API can be used to extract the social graph of a borrower;

(7) authorize the lender to obtain access and/or secure the loan against the borrower's qualified online account (or other attributes(s) as described in detail below); and

(8) other loan conditions, such as interest rate, repayment terms and schedule, what happens in case of default, for example.

The loan conditions described above are not an exhaustive list. Those skilled in the art know that other loan conditions may be part of the loan agreement between lender and borrower for the loan.

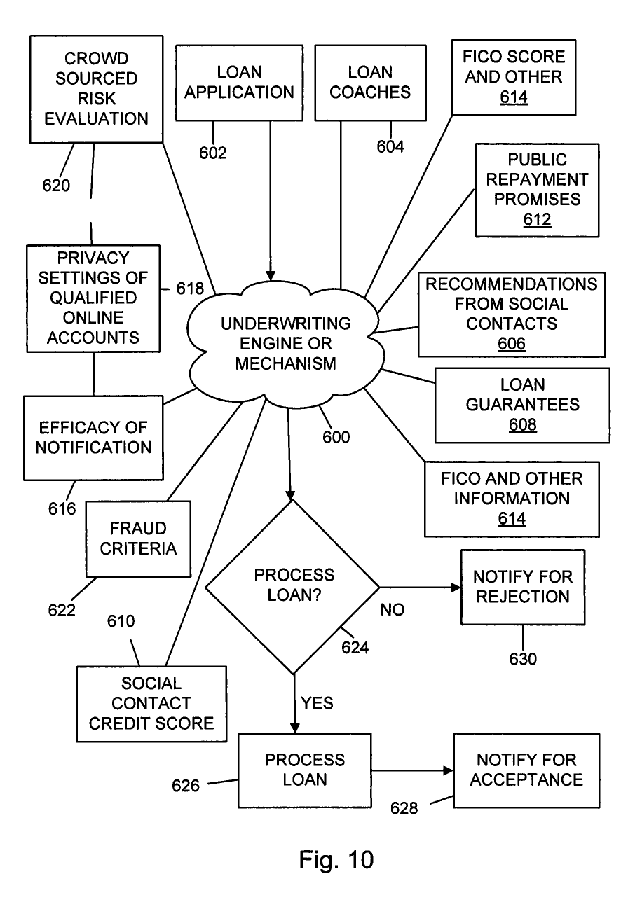

The lender may use certain underwriting criteria of the borrower to ultimately decide whether to award the loan to the borrower. Underwriting criteria or considerations are discussed more fully below with respect to FIG. 10, but certain criteria are described briefly with respect to FIG. 2 now.

In addition to underwriting criteria well known in the art, the present disclosure teaches that underwriting criteria may include one or more of the borrower's: social contact credit score, number of social contacts, amount of time the borrower uses the qualified account during a specified time period, the length of the qualified account use, and any other items that could show the propensity of the borrower to repay the loan (i.e., not default on any of the loan conditions). Underwriting criteria may also include one or more recommendations of one or more social contacts of the borrower, or a co-signature, or a guarantee from a social contact of the borrower for the loan.

In addition, a lender may consider other underwriting criteria including whether a borrower will be affected by public exposure (“efficacy of notification”) relating to the status of the loan. That is, the more private the borrower, the more likely loan status notification will affect the borrower. In an attempt to determine a propensity for privacy, the lender may evaluate the privacy settings of the borrower's qualified online account (or other qualified attribute). Algorithms may be employed to analyze a borrower's privacy settings. The lender may use various other means or mechanisms to evaluate a borrower's propensity for privacy, i.e., to ultimately determine whether a borrower will be affected by loan status notification. Along the same point, the lender may evaluate a loan application in which the borrower must answer whether or not he/she would be embarrassed if one or more social contacts of the borrower were notified of the status of the awarded loan as described herein. These are only examples. A lender may use crowd sourcing to evaluate and ultimately rate the borrower (as described in more detail below with respect to FIG. 10).

In addition, a lender may consider other underwriting criteria, such as the FICO scores, or other credit information of one or more social contacts of a borrower's qualified online accounts. Such social contacts are “loan repayment coaches” as described below. To a lender, the financial health of the social contacts of a borrower may reflect on the borrower's propensity to repay a loan. The financial information of the social contacts of a borrower may be required information in a loan application. Those skilled in the art know that other underwriting standards or criteria may be based on other facts known to those skilled in the art.

It is important to note that in some embodiments, underwriting criteria may improve with a greater number or a higher value of the borrower's social contact credit score, social contacts, friends, or other connections of the borrower, which all influence or are influenced by character. Underwriting criteria may also improve with one or more recommendations from one or more social contacts of the borrower. Underwriting criteria may further improve if one or more contacts of the borrower co-signs or guarantees the borrower's loan. Underwriting criteria may further improve depending upon the magnitude of qualified contents of the qualified online account (or other qualified attributes). Underwriting criteria may further improve depending upon the effect that loan status notification will have on the borrower, however, certain borrowers will not care about public exposure relating to the loan. Underwriting criteria may further improve depending upon the FICO scores, or other credit information, of one or more social contacts of a potential borrower's qualified online accounts.

In one embodiment as shown in FIG. 2, before the lender actually provides the loan to the borrower, i.e., before the lender actually advances the money to the borrower (or provides other credit), the lender may obtain access to the borrower's qualified online account (or other qualified attribute) and secure the loan against the borrower's qualified online account (collateral) at steps 85 and 90. The lender will obtain the borrower's account information to enable the lender to access the borrower's qualified online account. The lender may then secure the loan against the qualified online account in several ways. In one embodiment, the lender may work with a qualified online account service provider to take control of the borrower's qualified online account, i.e., restrict access to the borrower's qualified online account. In this sense, the lender may perform password changes to effect “restricting access.” The qualified online account service provider will, thus, prohibit the borrower from changing any qualified online account information (e.g., login name and/or password) to ensure that the lender has access and control over the borrower's online account until the borrower completely satisfies all loan conditions.

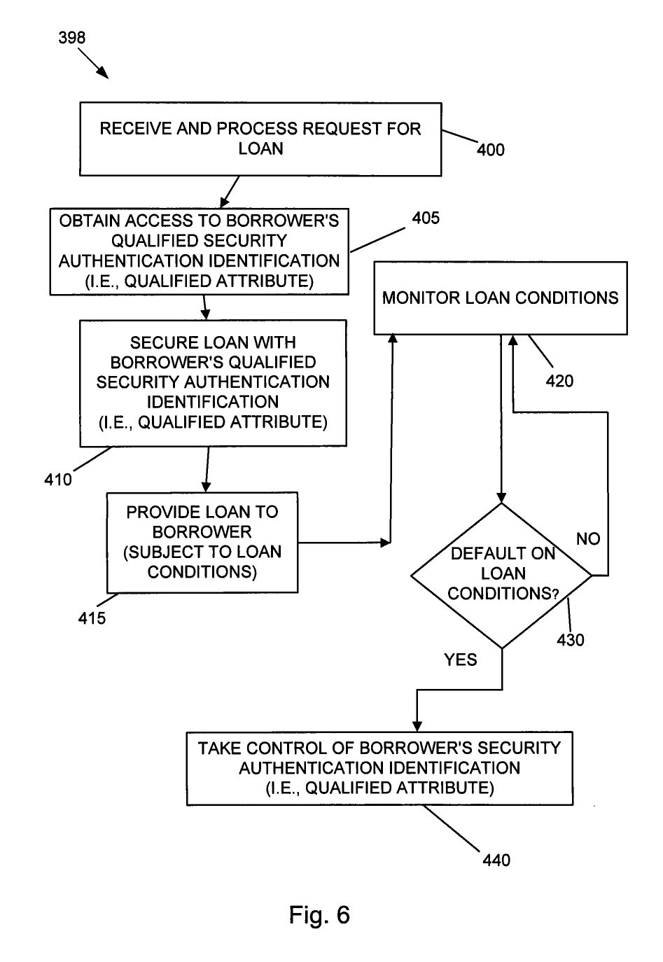

However, the borrower may access the borrower's qualified online account and qualified contents of the qualified online account directly (or indirectly through a proxy) through an application or app if the borrower abides by the loan conditions. In its broadest sense, the step of securing the loan against the borrower's qualified online account may be thought of or considered part of the process of obtaining access to the borrower's qualified online account. (It is noted that the method shown in FIG. 2 and described herein involves a qualified online account as one form of qualified attribute of the borrower. However, those skilled in the art know that this method applies to other types of qualified attributes, such as qualified security authentication identification as shown in FIG. 6).

FIG. 2A illustrates a block diagram 148 of the network relationships of computer systems (e.g., lender, borrower, and qualified online account service provider, respectively) for implementation of certain embodiments. As shown, a borrower's computer system 160 is linked to a service provider's computer system, such as a qualified online account service provider 150, via a communication link or network, using an app, to enable the borrower to access the borrower's qualified online account (or other qualified attribute as desired) as usual. The borrower's computer system 160 is also linked to a lender's computer system 170 (e.g., through the Internet or an app) to enable the borrower to apply for the loan (which may be done through third parties, such as loan originators or affiliates) and satisfy some or all of the loan conditions. As described above, access or use of a qualified online account (or qualified attribute as desired) may be made via a website (by browser) or other app that permits interfacing with a qualified online account (or qualified attribute as desired) with applications or apps, such as: a Facebook application, a LinkedIn application, an iPhone app, an Application Program Interface (API), an http request, a web server, a Remote Procedure Call (RPC), a Uniform Data Packet request (UDP), a Representable State Transfer (REST), a Simple Object Access Protocol (SOAP), etc.

FIG. 2A also illustrates a two-way network link (e.g., over the Internet or through using an app) between the lender's computer system 170 and the qualified online account service provider's computer system 150 in accordance with the loan agreement between the borrower and lender, in one embodiment.

In accordance with the loan conditions in some embodiments (e.g., borrower's authorization also known as permission), the lender will notify the service provider of the loan and of the authorization for the notification, and obtain access and take control over the borrower's qualified online account. The qualified online account service provider can then take appropriate action to prohibit the borrower from changing any account information to ensure that the lender has full access to the borrower's qualified online account. The lender will inform the qualified online account service provider when it may return unfettered control of the borrower's qualified online account to the borrower.

If the borrower defaults on the loan conditions, in one embodiment of the invention, the lender will take control over the borrower's qualified online account and restrict the borrower's access to the qualified online account (e.g., the lender will perform password changes, i.e., login with the borrower's login name and password and change them accordingly). Under this control, the lender may take other action as described below. Note that a qualified online account service provider can be a company, such as LinkedIn, that provides the LinkedIn relationship management service, or Google, Inc., that provides the Gmail service, for example. Note that, as described above, that authorization (permission) from the qualified online account service provider is a means by which the lender may gain access and control over a qualified online account of a borrower. However, those skilled in the art know that in certain other embodiments, the lender will not need to inform or obtain authorization (permission) from the qualified online account service provider for obtaining access and/or taking control of a qualified online account or other qualified attribute of a borrower. For example, a lender may not need to obtain authorization from a qualified online account service provider for obtaining, accessing, and taking control of a qualified online service account, such as an email account. As indicated above, this discussion relates to a qualified online account that is provided by a qualified online account service provider. Those skilled in the art know that other qualified attributes provided by other service providers may be relevant. For example, qualified security authentication identification (as the qualified attribute) may be used. A method involving qualified security authentication identification is shown in FIG. 6 and described below.

FIG. 2B illustrates a block diagram 149 of the network relationships of computer systems (e.g., lender, borrower, and qualified online account service provider, respectively), for implementation of certain embodiments. This embodiment 149 of securing the loan with the borrower's qualified online account, as shown in FIG. 2B, a lender's computer system 170 will act as a proxy for login and access by the borrower of the borrower's qualified online account (or other attributes). For example, the lender's computer system 170 could provide an email proxy to the email provided by the qualified account service provider's computer system 150. As part of the loan conditions, the borrower has provided, and the lender has stored, the borrower's current credentials including login and password on a server of the lender's computer system 170. The server may be a proxy server or another server. A proxy server of the lender's computer system 170 can automatically perform credential updates, i.e., login to the borrower's qualified online account (potentially using an app) and change the borrower's original login name and/or password to a new login name and/or password to prohibit the borrower from immediately accessing the borrower's qualified online account or other attributes (e.g., over the Internet or using an app from the borrower's computer system 160). The proxy server of lender's computer system 170 will then assign and store a proxy login name and password and associate it with the new actual login name and password stored in the proxy server of the lender's computer system 170. The proxy server will then provide the proxy login name and password to the borrower to enable the borrower to access the qualified online account via the proxy server of the lender.

With further reference to FIG. 2B, the borrower will typically be unaware of the actual new login name and password of the borrower's qualified online account (or other qualified attribute), and the borrower will also be unable to change the proxy login name and password with the current system. A proxy web interface that differs from the web interface (or app) of the actual qualified online account may be implemented with the proxy account access information or the actual web interface (or app) of the qualified online account may be used. As indicated above, the same is true for other qualified attributes, such as qualified security authentication identification. In one embodiment, a proxy might be thought of as a way that only the lender knows the true password of the qualified online account, and the borrower only knows the proxy password.

If the borrower abides by all loan conditions, the lender could (or will) return all control of the qualified online account to the borrower by providing the new actual login name and/or password to enable the borrower to access the qualified online account. The same is true of other qualified attributes. Alternatively, the proxy server will change the login name and/or password back to the original login name and password of the borrower. The borrower may retrieve the new or original login name and/or password by accessing such information from lender's computer system 170 by way of the borrower's computer system 160. However, if the borrower defaults on the loan conditions, the proxy server of the lender's computer system 170 will automatically (or provide the option to) prevent the borrower from accessing the borrower's qualified online account (or other qualified attributes). The lender's computer system 170 may also perform other functions resulting from the default as described below.

In yet another embodiment of securing the loan, the lender may merely rely on the loan conditions (e.g., loan covenants) in the loan agreement to restrict the borrower from changing qualified online account access information (or information from other qualified attributes).

In yet another embodiment of securing the loan against the qualified online account, the lender may take a security interest in the borrower's qualified online account by filing, for example, a Uniform Commercial Code 1 (UCC1) financial statement, or a Uniform Commercial Code 9 financial statement, for the account and its contents at the appropriate governmental agency (e.g., Secretary of State for the state or the county recorder for the county in which the borrower is located, or in which the account is located, as appropriate). In addition, the lender may file the security interest at the U.S. Copyright Office or other intellectual property registry for the qualified contents of the qualified online account. These techniques may be used alone or in combination with the processes described above for securing the loan. These techniques may be used with other qualified attributes, such as qualified security authentication identification.

Now, returning to method 78 of FIG. 2, before the lender actually provides the loan to the borrower, the lender may assess fraud criteria of the borrower. That is, the lender may check with Federal, state, and local authorities and agencies for criminal activity (e.g., fraud or terrorism) and confirm the identity of the borrower. Anti-fraud and identity verification systems may be employed (e.g., to check relevant databases). Assuming the borrower's record is “clean” and identity is confirmed, and once the borrower has provided all the necessary information and adhered to all lender requirements, the lender may provide the loan (advance the money) to the borrower (subject to the loan conditions) at step 100. Note that providing a loan to a borrower contemplates involving third parties, such as (1) a loan originator, such as PayPal or a Chase credit card for example, and/or (2) a loan facilitator, such as a loan broker or affiliate. As described above with respect to underwriting criteria, note that the lender may require that the borrower adhere to additional loan conditions before advancing the loan (or a series of loans) to the borrower (in addition to those described above). Those skilled in the art will know that additional requirements may be imposed on the borrower before the loan is approved and advanced to the borrower.

With further reference to FIG. 2, execution then moves to step 120 wherein the loan conditions are monitored to ensure that the borrower is abiding by such conditions. For example, the lender will monitor whether the borrower is making timely payments. A lender's computer system can perform or implement certain actions under this monitoring step. However, in some embodiments, human interaction may be desired or required for other conditions. If the computer does not detect a default of any of the loan conditions (e.g., a failure to make timely payment by the borrower) at decision step 130, the method 78 returns to step 120 to continue monitoring performance on the loan. If, however, the lender's computer system detects a default on loan conditions by the borrower at decision step 130 (e.g., if the borrower fails to make one or more payments that is required by the loan conditions of the loan agreement between the lender and borrower), the method moves to execution step 140 wherein the lender takes control of the borrower's qualified online accounts (collateral). Control may be in the form of seizure of the borrower's qualified online accounts (or other qualified attributes as employed). Control may also be in the form of turning off or shutting down the qualified online account (or other qualified attribute). In some embodiments, control may include restricting the hours of access or limiting the functionality of the qualified online attribute.

Taking control may also include turning off other property of the borrower. This is represented as reference block 142 in FIG. 2. For example, the lender may turn off other property of the borrower, including automobiles, boats, home appliances, or other property of the borrower. Taking control may also include notification of one or more social contacts of the borrower. Notification may occur as described below.

In one embodiment, the components of the lender's computer system 170 that detect the default may send the appropriate signal to execute this control by accessing the borrower's qualified online account (or other qualified attributes). In the event the qualified online account service provider has agreed to prohibit the borrower from changing the login name and/or password as described above in one embodiment, the lender's computer system 170 will automatically log into the borrower's qualified online account over the Internet through the relevant website (e.g., www.facebook.com), or contact through an “app” and change the login name and/or password to prevent the borrower from accessing the borrower's qualified online account (and all pages) (or other qualified attribute(s)) until the borrower remits full payment as required by the loan conditions.

As indicated above, taking control of a borrower's attribute may include notification. For example, the lender may notify social contacts of the borrower of the default of the loan conditions. This notification could be done by posting on a wall, sending an email or a text message, making a phone call to the social contacts, sending texts (SMS), instant messaging, or other means or mechanism. Under the loan conditions (terms of the loan), the lender may notify friends or contacts of the existence of the loan, non-default, default of the loan conditions, or anything authorized by the loan agreement between the lender and borrower.

As part of the process, the lender may evaluate information relating to the borrower's qualified online account (or other qualified attribute) to determine whether the borrower will be affected by public disclosure of the status of a loan. That is, the lender will evaluate the efficacy of notification of the borrower, as described in more detail below. (As indicated above, the method in FIG. 2, and the high level network of relationships of systems in FIGS. 2A and 2B, and the corresponding discussion herein involve a qualified online account as one form of qualified attribute of the borrower. However, those skilled in the art know that this method can apply to other types of qualified attributes, such as qualified security authentication identification as shown in FIG. 6).

In an effort to assess efficacy of notification of a borrower, the lender may evaluate information relating to the borrower's qualified attributes, loan application or other information. For example, the lender may evaluate privacy settings of borrower's qualified online accounts, analyze current social contacts of the borrower, and/or compare the borrower's profile with the profiles of the social contacts of the borrower to assess whether the borrower will repay a loan. If the borrower is connected to a community of social contacts with good credit, the borrower may be a better risk for the lender. Information in a loan application will be reviewed as well. The loan application may require that the borrower write an essay describing how he/she plans to repay a loan. These are suitable examples. The lender may evaluate other information to assess risk as known by those skilled in the art. The lender may incorporate crowdsourced risk evaluation to evaluate such information as discussed in more detail below.

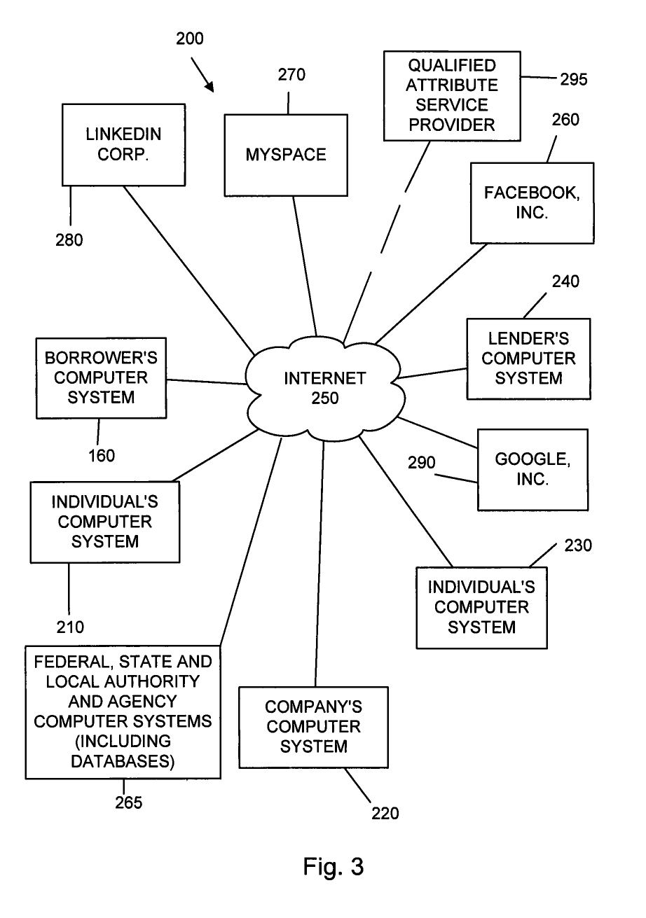

FIG. 3 illustrates a basic network diagram according to one embodiment. In FIG. 3, a network architecture 200 is schematically shown that may be used for embodiments of the present invention. The network architecture 200 includes one or more individual and/or company computer systems 210, 220, 230, a borrower's computer system 160, and a lender's computer system 240 connected via the Internet 250 to one or more computer systems 260, 270, 280, 290 of the qualified online account service providers. Examples shown include computer systems of Facebook, Inc., MySpace, Google, Inc. (Gmail), and LinkedIn Corporation. The network architecture 200 may include other service providers 295 of other qualified attributes of the borrower. Such service providers 295 are shown in dashed lines connected to the Internet.

The service providers' computer systems each typically include, among other computer components or equipment, one or more servers for the websites of the qualified online account service providers (or one or more incoming and outgoing email servers for service providers, such as Google, Inc., for Gmail) or apps. These servers or apps may be accessed by means of an http request, APIs or apps as well as other means known to those skilled in the art. The computer systems described above may also include one or more conventional components, such as one or more desktop and/or laptop computers and/or servers, each of which includes conventional components, such as one or more processors, memory, video cards/interfaces, network cards, storage devices, and possibly display units.

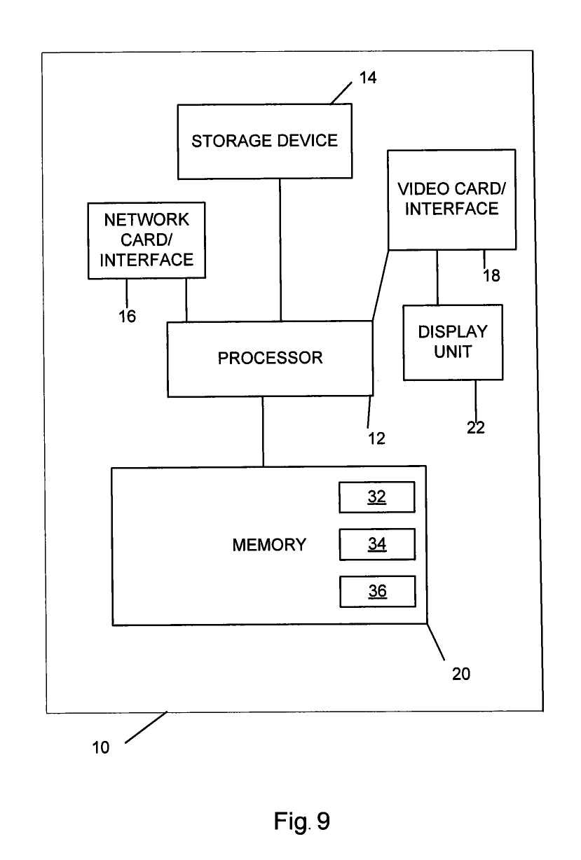

For example, a typical computer system 10 is shown in FIG. 9 wherein a processor 12 is connected to storage device 14, network card 16, video card/interface 18, and memory 20. A display unit 22 is connected to the video card/interface 16. The computer system 10 may include other conventional components known to those skilled in the art. Various computer components may be instantiated on the computer system 10, with executable components stored in memory 20. For example, the memory 20 may store executable instructions for a first computer component 32 for obtaining access to a qualified attribute of a borrower, a second computer component 34 for monitoring whether the borrower is in default, and a third computer component 36 for taking control of the qualified attribute upon a borrower's default. In FIG. 3, the computer systems of four service providers are shown, but those skilled in the art know that any number of social networking companies may be used. For purposes of this discussion, the borrower has applied for a loan using the lender's computer system 240, via the Internet 250, and received a loan from the lender. The computer system 10 shown in FIG. 9 and described herein is an example of a suitable computer system. However, those skilled in the art know that computer systems with some and/or different components may be employed. For example, the computer system may be a server that does not incorporate a display unit or video card. Other systems also exist as known by those skilled in the art.

The lender's computer system 240 has stored account information about borrowers and their qualified online accounts (or qualified attributes) including login names and passwords. This information may be stored in a database or other formats. The lender's computer 240 will also perform several functions (i.e., execute steps of algorithms) including monitoring whether the borrower complies with the loan conditions, e.g., makes timely payments to repay the loan described above. The lender's computer system 240 will detect a default of the loan conditions by the borrower and take some suitable action, e.g., automatically (preferably) take control of the borrower's qualified online account(s) or other qualified attribute(s). Taking control may be prohibiting login, deleting or suspending the qualified online account or other qualified attributes, or other measures including technical countermeasures. Taking control may also manifest as displaying a warning to the borrower when the borrower attempts to access the borrower's qualified online account(s) or other attributes, or prompting the borrower with a mechanism for immediate payment to satisfy the loan before providing access.

Notwithstanding the way in which the lender has secured the loan against the borrower's accounts (or other qualified attributes) as described above, in one embodiment, the lender's computer system will automatically perform password changes, or update other credentials, i.e., change the borrower's account login name and/or password to prohibit the borrower from accessing all accounts. The lender's computer system 240 will also provide the option to bring the loan current, or otherwise cure a default condition, or automatically notify any or all social contacts associated with the borrower's qualified online accounts (or other qualified attributes) about the loan, a default of the loan conditions and/or anything else authorized under the loan agreement between lender and borrower.

The lender's computer system 240 may also incorporate algorithms for evaluating the information relating to the borrower's qualified online account (or other qualified attribute) to determine whether the borrower will be affected by any public disclosure of the status of a loan. These algorithms will ultimately evaluate the efficacy of notification of the borrower as described in more detail below. The notification may be by email, internal account messaging, account wall, text message, phone call, or other means. The notice may continue until the borrower makes due on any and all of the loan conditions. Alternatively, such notification can be made while a borrower is not in default on the loan conditions.

The lender's computer system 240 may also incorporate appropriate algorithms necessary to connect to Federal, state, and local authority and agency computer systems (represented collectively as reference 265 in FIG. 3) to check the databases of the Federal, state, and local authorities and agencies for criminal activity (e.g., fraud or terrorism) and confirm the identity of the borrower. Anti-fraud and identity verification systems may be employed; that is, fraud and other criminal activity can be considered.

In some embodiments, the borrower may agree to turn over the borrower's qualified online account (or other qualified attribute) to the lender under the loan agreement. In this respect, the lender prohibits the borrower from accessing the account (at all) until the borrower has complied with all loan conditions. In this instance, the qualified online account (or other qualified attribute) is effectively placed in escrow. Once the borrower has complied with all loan conditions (e.g., paid off the loan in full), the lender will return full access to the borrower's qualified online account to the borrower.

FIG. 4 is a flowchart illustrating a method 298 according to a further aspect of the present disclosure. In the embodiment of FIG. 4, method 298 begins with step 300 wherein a lender receives and processes a potential borrower's application for a loan. At step 310, the lender secures the loan with the borrower's qualified online account (or other qualified attribute). Steps 300, 305, and 310 are similar enough to steps 80, 85, and 90 shown in FIG. 2 and described above. Therefore, additional details will not be repeated. At step 320, a loan is provided to a borrower subject to loan conditions similar step 100 in FIG. 2. However, in method 298, the lender provides the loan via a qualified payment account. Examples of such accounts include a Visa® credit card account, MasterCard® credit card account, PayPal Account, Automated Clearing House (ACH) and Electronic Funds Transfer (EFT) networks and systems. As one example, the lender may provide a prepaid Visa credit card with the amount of the loan or the lender may advance the loan to the borrower's PayPal Account. These are only examples. Those skilled in the art know that other qualified payment accounts may be used.

Similar to step 120 in FIG. 2, in step 330 the lender will monitor the loan conditions to ensure that the borrower is satisfying its obligations including making payments to the lender. The lender may receive loan payments many ways. In one embodiment, the lender may receive loan payments via a qualified payment account. This is performed at step 340.

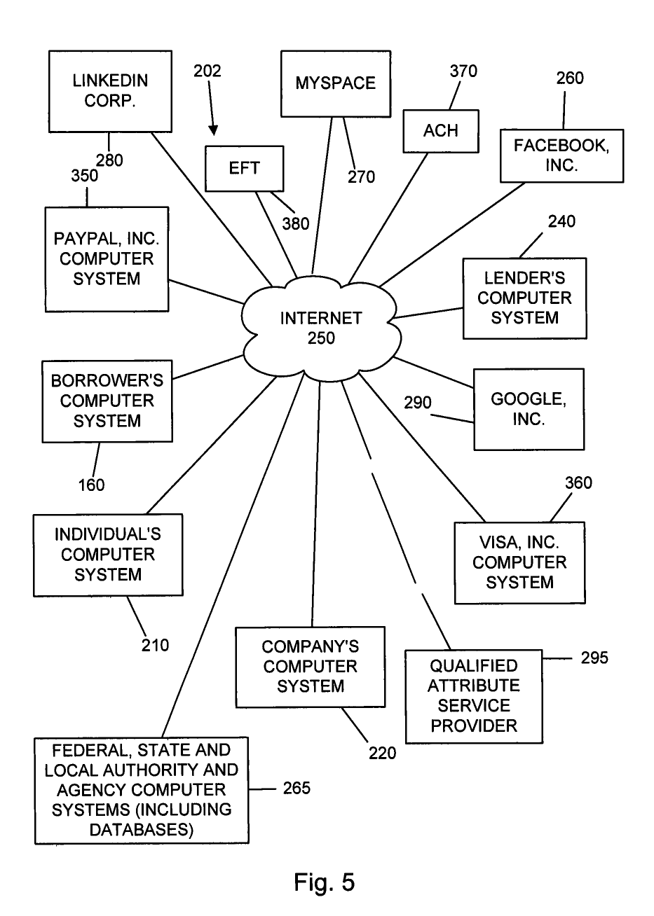

FIG. 5 illustrates a network diagram 202 according to one aspect of the present disclosure. The network architecture 202 is similar to network architecture 200 of FIG. 3, but FIG. 5 also illustrates several qualified payment account providers. In particular, a network architecture 202 is schematically shown that may be used for various embodiments of the invention. The network architecture 202 includes one or more individual 210 and/or company computer systems 220, the borrower's computer system 160, and a lender's computer system 240, connected via the Internet 250, to one or more computer systems and networks 350, 360, 370, and 380 of the qualified payment account providers. Examples of qualified payment providers shown include computer systems of PayPal, Inc. 350, Visa, Inc. 360, ACH 370, and EFT 380. (Other qualified attributes 295 are represented in dashed lines as in FIG. 3).

The qualified payment providers' computer systems typically each include, among other computer components or equipment, one or more servers for qualified payment account providers. The computer systems described above may also include one or more conventional components, such as one or more desktop and/or laptop computers and/or servers, each of which that may include conventional components, such as one or more processors, memory, network cards/interfaces, storage devices, and possibly video card and display units. The computer systems of four qualified payment account providers are shown, but those skilled in the art know that any number of qualified payment account providers may be used. For purposes of this discussion, the borrower has applied for a loan through lender's computer system 240 via the Internet 250, and received a loan from the lender.

FIG. 6 is a flowchart illustrating a method 398 in accordance with another embodiment of the present disclosure. The method 398 begins in FIG. 6 when a lender receives and processes a request for a loan by a potential borrower at step 400. Step 400 is similar to step 80 in FIG. 2, and may vary depending upon the specific implementation. Step 400 may be accomplished, e.g., through the lender's website, a third-party website, an API, an “app”, directly by paper application, or orally. As part of the process, and subsequent agreement (written, electronic, or oral) between lender and borrower, the lender will require, and the borrower will agree to adhere to certain loan conditions, such as (1) to offer access to the borrower's qualified security authentication identification; (2) to provide the borrower's qualified security authentication identification information (e.g., URL for OpenID); (3) that borrower will not change its qualified security authentication identification until the borrower has complied with all loan conditions, (e.g., repaid the loan in full), but advise the lender of any and all other changes to the borrower's qualified security authentication identification; (4) authorize the lender to periodically login to various accounts of the borrower that use the qualified security authentication identification to ensure that such identification has not changed; (5) authorize the lender take control of the borrower's qualified security authentication identification (as described below); (6) authorize the lender to secure the loan against the borrower's qualified security authentication identification (as described in detail below); and (7) other loan conditions, such as, interest rate, repayment terms and schedule, and what happens in case of default, for example. The loan conditions described above are not an exhaustive list. Those skilled in the art know that other loan conditions and/or variations of these loan conditions may be part of the loan agreement between lender and borrower for the loan.

As indicated above with respect to the method of FIG. 2, the lender may use certain underwriting criteria of the borrower to ultimately decide whether to award the loan to the borrower. Underwriting criteria can include the borrower's social contacts, social contact credit score, borrower's and social contacts' FICO scores, the amount of use of the borrower's security authentication identification, and any other items that could show the propensity of the borrower to repay the loan (i.e., not default on any of the loan conditions). This is discussed above and in more detail below with respect to FIG. 10.

Steps 405, 410, and 415 are similar to steps 85, 90, and 100 in FIG. 2 in that the lender will obtain access to borrower's qualified security authentication identification (qualified attribute), secure the loan, and the lender will provide the loan subject to the loan conditions, respectively. However, at steps 405 and 410, the lender will obtain access to the borrower's qualified security authentication identification, and secure the loan with the borrower's qualified security authentication identification (instead of, or in addition to, the borrower's qualified online account as in steps 85 and 90 in FIG. 2). Examples of a qualified security authentication identification include: uniform resource locators (URLs) and extensible resource identifier (XRIs) for OpenID, extensible markup language (XML), security assertion markup language (SAML), protocols for JanRain, and tokens for open authorization (OAuth). Those skilled in the art know that any other qualified security authentication identification (i.e., other protocols, codes, software, or other electronic mechanisms to authenticate a borrower online) may be used as security for the loan. The lender will secure the loan with the qualified security authentication identification in several ways. In one way, the lender will work with the qualified security authentication identification provider (e.g., Google, Inc.), to ensure that the borrower will not change the qualified security authentication identification.

The lender will then provide the loan to the borrower subject to the loan conditions at step 415 (similar to step 100 in FIG. 2).

Step 420 and decision step 430 are similar to steps 120 and 130 in FIG. 2 described above. Therefore, they will not be described here in detail, but it is noted that steps 420 and 430 may take on any suitable form depending upon the desired implementation.

Now, in the event the borrower defaults on the loan at step 430, the lender will take control over the borrower's online security authentication identification at step 440. The lender may notify the qualified security authentication provider that the borrower is in breach, and instruct it to disable, or prohibit, any relying party requested by a borrower, from identifying the borrower via the borrower's qualified security authentication identification.

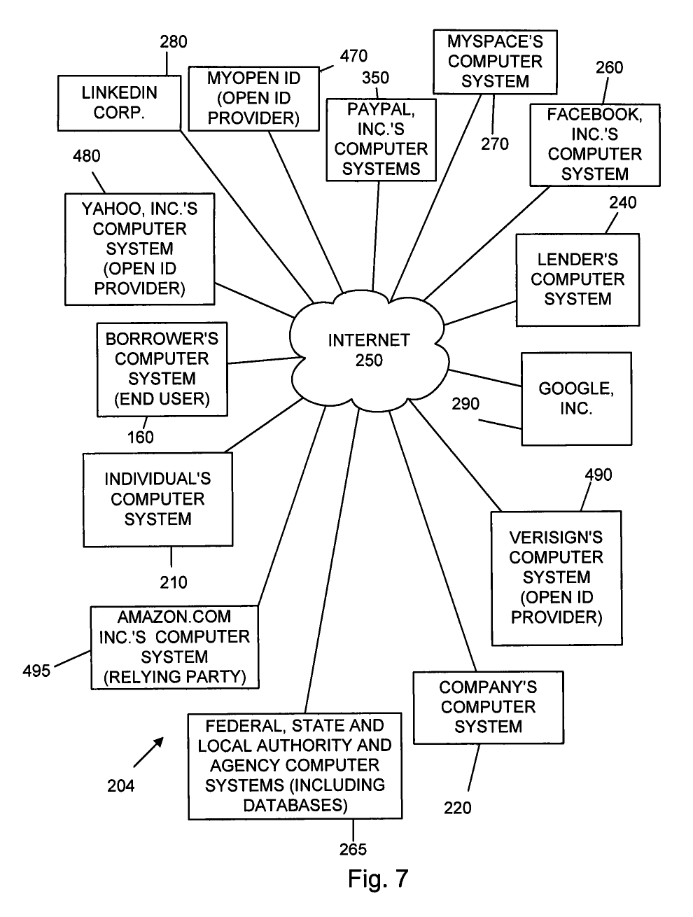

FIG. 7 is a network diagram suitable for certain implementations of the present invention. The network diagram here is similar network architecture as shown in FIGS. 3 and 5, but FIG. 7 illustrates several qualified security authentication providers and relying parties. In particular, a network architecture 204 includes one or more individual and/or company computer systems 210, 220, a borrower's computer system 160, and a lender's computer system 240, connected via the Internet 250, to one or more computer systems and networks of the qualified payment account providers. Examples shown include computer systems of MyOpen ID 470, Verisign, Inc. 490, and Yahoo, Inc. 480 as OpenID providers, and Amazon.com, Inc. 495 as a relying party.

The qualified security authentication providers' computer systems typically each include, among other computer components or equipment, one or more servers or apps for qualified payment account providers. The computer systems described above may also include one or more conventional components, such as one or more desktop and/or laptop computers and/or servers, each of which includes conventional components, such as one or more processors, memory, network cards/interfaces, storage devices, and possibly video cards and display units. The computer systems of three qualified security authentication providers (and one relying party) are shown, but those skilled in the art know that any number of providers and relying parties may be used. For purposes of this discussion, the borrower has applied for a loan via lender's computer system 240, via the Internet 250 (or by using apps), and received a loan from the lender.

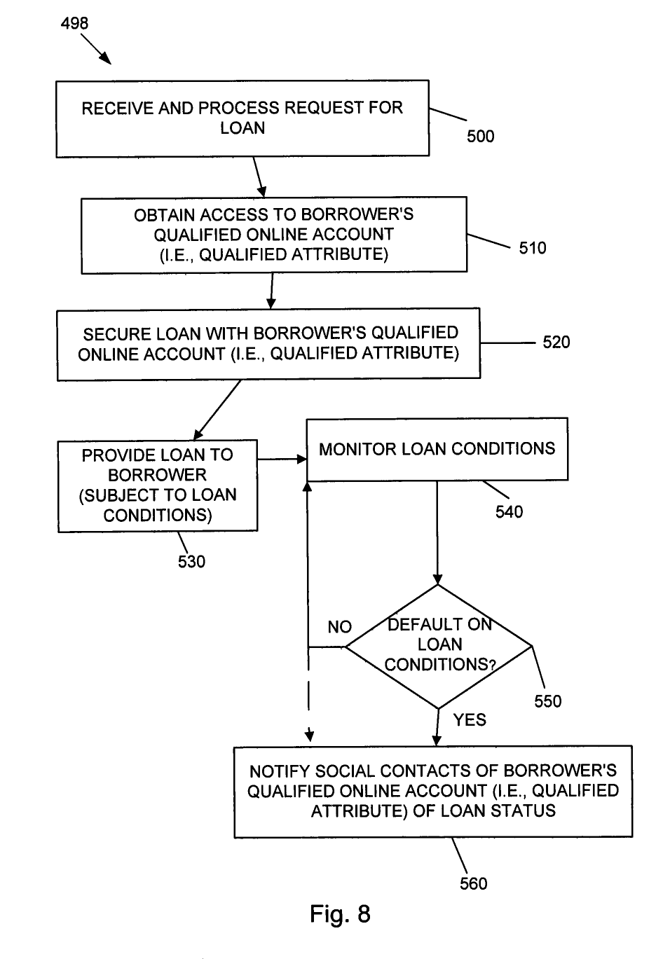

FIG. 8 is a flowchart illustrating an aspect of the present teaching. In FIG. 8, a method 498 begins with step 500 wherein a lender receives and processes a potential borrower's application. Step 500 can be similar to step 80 of FIG. 2, with specific behavior depending upon the desired implementation. Steps 500, 510, 520, 530, and 540 are similar to steps 80, 85, 90, 100, and 120 in FIG. 2 as described above. As these steps are similar to earlier steps, and those skilled in the art would readily identify differences, no further explanation will be given. The method 498 then moves to decision step 550. If the computer does not detect a default of any of the loan conditions, e.g., a failure to make timely payment by the borrower, at decision step 550, the method returns to step 540. If, however, the computer system detects a default by the borrower at decision step 550, e.g., if the borrower fails to make one or more payments that are required by the loan conditions of the loan agreement between the lender and borrower, the method moves to execution step 560, wherein borrower's social contacts will be notified of the status of the loan. That is, the lender will notify the social contacts of the default. In particular, the lender may optionally notify all social contacts of the borrower, or only notify loan repayment coaches of the borrower. That is, the lender may only notify those social contacts with an adequate FICO score or other credit information as determined by the lender during the underwriting process. However, even if the borrower has timely made payments under the decision step 550, the lender may also notify the borrower's social contacts of the loan status. In this case, the notification may advise the borrower's social contacts of the borrower's timely payment(s) or meeting other loan conditions. This is identified in FIG. 8 by a dotted line. This type of notification is optional.

In certain embodiments, the one or more of the steps of method 498 shown in FIG. 8 may be implemented, performed, or initiated by any of the high-level block diagrams of the network relationships (e.g., lender, borrower, and service provider, respectively) described with reference to FIGS. 2A and 2B and the network diagram illustrated in FIG. 3. In some cases, the lender, borrower, service provider, etc. may use a computer system. As discussed above, the computer system 10 illustrated in FIG. 9 is an example of a computer system that may be used to implement, to perform, or to initiate any part or all of the various method steps or operations in accordance with various embodiments of the present invention.

FIG. 10 is an underwriting flow diagram in accordance with some embodiments of the present invention. In FIG. 10, an underwriting engine 600 or mechanism receives a loan application 602 (or other suitable information) of applicant borrower. The loan application will include substantive information about the borrower that will be used as part of the underwriting process. As part of the underwriting evaluation, underwriting engine 600 also receives several sources of information including: the presence of loan repayment coaches 604, recommendations of social contacts of the borrower's qualified online accounts 606, loan guarantees 608 from social contacts, social contact credit score 610, community or public repayment promises (to repay loan) 612, and FICO Score and other traditional financial information 614 of the borrower as well as the social contacts of the borrower. To a lender, the financial health of the social contacts of a borrower may reflect on the borrower's propensity to repay a loan. The financial information of the social contacts of a borrower may be required information in a loan application.

In addition, the underwriting engine 600 will receive and evaluate efficacy of notification information 616 of the borrower. As indicated above, efficacy of notification will tend to indicate whether a borrower will be affected by public exposure relating to the status of the loan. For example, the more private the borrower, often the more likely loan status notification will affect the borrower. In an attempt to determine a propensity for privacy, the lender may evaluate the privacy settings 618 of the borrower's qualified online account (or other qualified attribute). Algorithms may be employed to analyze a borrower's privacy settings. Crowdsourced risk evaluation 620 may be used to analyze the privacy settings (discussed in more detail below). The lender may use various other means or mechanisms to evaluate a borrower's propensity for privacy, i.e., to ultimately determine whether a borrower will be affected by loan status notification. Along the same point, the lender may evaluate a loan application in which the borrower must answer whether or not he/she would be embarrassed if one or more social contacts of the borrower were notified of the status of the awarded loan as described herein. These are only examples. Those skilled in the art know that other underwriting standards or criteria may be based on other facts known to those skilled in the art.

As part of the underwriting evaluation, the underwriting engine 600 will also receive information from crowdsourced risk evaluation 620. Crowd sourcing may be used to evaluate hard to quantify aspects of the borrower's willingness to make timely payment. Crowd sourcing may be used to evaluate the privacy settings of the borrower's qualified online accounts or evaluate the responses in a borrower's loan application. (A dashed line is shown from privacy settings reference block 618 to crowdsourced risk evaluation block 620.) For example, crowd sourcing may be used to evaluate an essay in the borrower's loan application describing how the borrower expects to make payments on the loan. Crowd sourcing may be used to evaluate information in the borrower's qualified online accounts or other qualified attributes. For example, crowd sourcing may be used to compare the borrower's profile to profiles of the social contacts of the borrower, or other online individuals with favorable or unfavorable credit. These are only examples. However, those skilled in the art know that crowd sourcing may be used to evaluate other kinds of information of the borrower to determine whether the borrower is more, or less, likely to repay the loan. In addition, the underwriting engine will receive fraud criteria 622 to evaluate the borrower as described above.

Now, utilizing all available information, the underwriting engine 600 evaluates the borrower to determine whether to process the loan at decision 624. If the evaluation is favorable to the borrower, the loan is processed at block 626 and the borrower is notified of the acceptance at block 628. If the borrower does not satisfy underwriting standards, the loan is not processed and the borrower is notified of the rejection at block 630. In some embodiments, the rejection provided to the borrower can include one or more tips, comments, or nuggets of information that tell the borrower how to improve their chances of getting approved. The tips, comments, and/or nuggets of information can be customized to the specific loan application provided by the borrower or they can be generic.

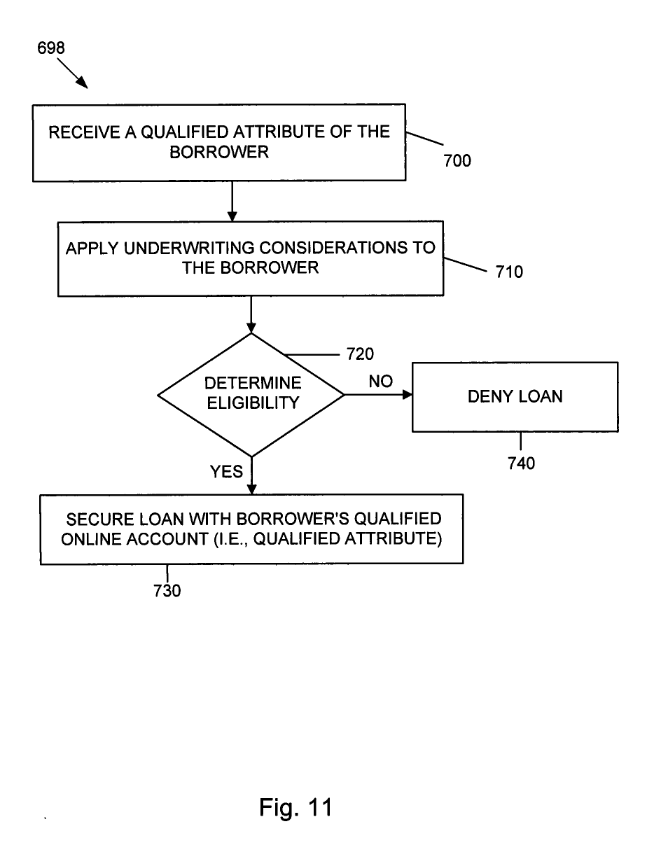

FIG. 11 is a flowchart illustrating the underwriting and approval process 698 in accordance with the embodiments of the present invention. As illustrated in the embodiments shown in FIG. 11, a qualified attribute of the borrower is received at set 700. Once received, step 710 applies underwriting considerations to the borrower. As discussed above, the underwriting considerations can include several sources of information, such as, but not limited to, the presence of loan repayment coaches, efficacy of notification, privacy settings, crowdsourced risk evaluation, recommendations of social contacts of the borrower's qualified online accounts, loan guarantees from social contacts, social contact credit score, community public repayment promises (to repay loan), FICO, and other criteria.

Using the underwriting considerations, eligibility determination operation 720 determines whether the borrower is eligible for the loan. If the borrower is eligible, determination operation 720 branches to security operation 730 which secures the loan with the borrower's qualified online account (i.e., the qualified attribute). If determination operation 720 determines that the borrower is not eligible, the loan is denied via a denial operation 740.

As will be appreciated, the present teaching can take on a plurality of various implementations depending upon the desired behavior of the system. Just a few of these possible implementations are mentioned below.

One embodiment of this invention includes the method and system of underwriting criteria to include a formula (one suitable example formula is provided below) of interlinking of electronic publications, referencing and written by a loan applicant, with similar electronic publications, referencing or written by relatives, friends, or business associates of the applicant.

One embodiment of this invention includes the method and system of improving the likelihood of a positive loan default outcome by a creditor by altering the electronic publications referencing and originally written by a borrower to indicate that the loan is in default.

One embodiment of this invention includes the method and system of lowering the cost of credit by a borrower by counter-loaning a property or properties consisting of electronic publications referencing and written by the borrower to a creditor. Upon acceptable repayment of the dollar loan the property is returned to the borrower.

One embodiment of this invention includes the method and system of improving the likelihood of a positive loan default outcome by a creditor, by altering the electronic publications referencing and originally written by a borrower, by altering or reducing the number of links to the borrower's relatives, friends, or business associates.

One embodiment of this invention includes the method and system of improving the likelihood of a positive loan default outcome by a creditor by unpublishing the electronic publications referencing and originally written by a borrower.

One embodiment of this invention includes the method and system of using loan collateral of electronic publications referencing and originally written by a borrower by altering the method of access to said publication(s) via a proxy server. This could be both for the borrower's access, such as their login, or for the access to the content of the web pages, which in fact incorporate only content served by the proxy server. The proxy server is under the control of the borrower.

One embodiment of this invention includes the method and system of the use by a creditor for the purpose of collateral of a proxy server that sits between the normal host of electronic publications and the owner of those publications.

One embodiment of this invention includes the method and system of the use by a creditor for the purpose of collateral of a proxy server that sits between the normal host of electronic publications and the viewers of those publications.

One embodiment of this invention includes the method and system to increase the likelihood of timely loan repayment by a borrower to a creditor by the use of regularly updated (altered) login credentials provided by the creditor to the borrower for access to email, on-line documents, on-line publications, or electronic publications referencing and written by the borrower.

One embodiment of this invention includes the method and system of the use by a creditor for the purpose of collateral, login credentials provided by the creditor to a borrower for access to social networks, email, on-line documents, on-line publications, or electronic publications referencing and written by the borrower.

One embodiment of this invention includes the method and system to increase the likelihood of timely loan repayment by a borrower to a creditor by the creditor providing regular communications to and monitoring regular communication from a set of friends, relatives or business associates of the borrower who have been predetermined to be appropriate for the task of loan repayment coaching (credit scores, closeness to borrower, etc.), wherein said communications occur through social networks, email, on-line documents, on-line publications, or electronic publications referencing and written by the borrower.

One embodiment of this invention includes the method and system to measure the credit risk of a borrower by a creditor analyzing the credit worthiness and closeness of links of a set of friends, relatives, or business associates of the borrower, wherein said analysis occurs through social networks, email, on-line documents, on-line publications, or electronic publications referencing and written by the borrower.

One embodiment of this invention includes the method and system to automate loan approval and execution using the credit worthiness and closeness of links of a set of friends, relatives, or business associates of a borrower, wherein said analysis occurs through social networks, email, on-line documents, on-line publications, or electronic publications referencing and written by the borrower.

One embodiment of this invention includes the method and system to measure a credit score of a borrower by aggregating the credit risk assigned to the borrower by a selected group of friends, relatives, or business associates of the borrower, wherein the solicitation of said credit risks is via social networks, email, on-line documents, on-line publications, or electronic publications referencing and written by the borrower.

One embodiment of this invention includes the method and system to increase the likelihood of timely loan repayment, dynamically update a loan interest rate; dynamically update a credit score, and manage a loan by a creditor by providing regular communications to and monitoring regular communications from a set of friends, relatives or business associates of a borrower who have been predetermined to be appropriate for the task of loan repayment coaching (credit scores, closeness to the borrower, etc), wherein said communications occur through email, on-line documents, on-line publications, or electronic publications referencing and written by the borrower.

One embodiment of this invention includes the method and system to secure a loan by a creditor to a borrower by replacing the borrower's credentials to a social network by a new set of credentials provided by the borrower, for the life of the loan.

One embodiment of this invention includes the method and system to compute a credit-worthiness score of a potential borrower by the following formula:

SB=k1*p*[(sum(sn*fn)−sum(sm*fm)]+o, where:

SB=computed credit-worthiness score,
k1=a first constant,
sn=the credit-worthiness of n affiliated users in a first subset of affiliated users,
fn=the frequency of contact between each affiliated user in the first subset and the potential borrower,
sm=the credit-worthiness of m affiliated users in a second subset of affiliated users,
fm=the frequency of contact between each affiliated user in the second subset and the potential borrower,
p=the computed value of privacy of the potential borrower,
sum( ) refers to the sum of all internal products over n or m quantity affiliated users in each of the two subsets,
o=a second constant.

### TERMS AND DEFINITIONS USED IN THIS PATENT APPLICATION

Unless designated otherwise, the definitions for the terms below in the singular apply to the same term(s) in the plural and vice versa. The below definitions are not necessarily absolute, but are provided to facilitate the reader's understanding of the present disclosure. The context wherein a term is found, the entire present teaching including the below definitions, and the knowledge of one skilled in the art, serve to define the meanings of the terms herein.

“Account information” or “account access information” means credentials or information used to obtain access to a qualified attribute. Account information could include username, login name, password, secret questions/answers used for authentication, usernames and password by use of proxy logins, authentication tokens, secret questions, password reset questions, authentication schemes such as OAuth or SecurID® devices, etc.

“Affiliated users” means a group of individuals or legal entities who have individually chosen to be affiliated to all, or a subset, of the other affiliated users by virtue of a shared interest or commonality of friendship, relationship, business association, or health status, and wherein all of the affiliated users (e.g., borrowers) have one or more social network accounts.

“Application” or “app” means a computer component or system with ability to access, communicate, or work with other computer components or systems. Such an app might be a Facebook app, a LinkedIn app, an iPhone app, an Android app, an Application Program Interface (API), an http request, a web server, a Remote Procedure Call (RPC), a Uniform Data Packet request (UDP), a Representable State Transfer (REST), a Simple Object Access Protocol (SOAP), etc. The app might access, communicate, or work with the qualified online account service provider or qualified security authentication provider, or provide services related to the user's credentials, including proxy or monitoring services. Apps on the qualified online service platform usually, but not absolutely, use some services provided by the qualified online service. Such available services include hosting, memory, execution, visual display, data input, an API, and access to resources within the qualified online service that are not directly or equally available to the user. Apps frequently combine services provided by the qualified online service with services and/or communications not provided by the qualified online service.

“Assignment of the contents of the qualified attribute,” “assignment of qualified contents of the qualified online account,” “assignment,” or “assignment of qualified content,” means borrower's interest or ownership in the qualified content is assigned or transferred to the lender or a third party, such as a trustee, until the loan is repaid, or some other necessary condition is met. In some implementations, the ownership interest of the borrower is pledged, pawned, or held by a trustee.

“Billers” are entities that bill after a service or utility has been provided, often because the value or quantity of the service or utility is not known in advance. Examples include electricity, gas, water, sewer, trash, legal services, and ISPs, as well as car and equipment rental, phone and cell phone charges, cable TV, and wireless bandwidth charges. Billers can be lenders.

“Borrower” means an entity (i.e., person, company, institution, or other organization), or group of entities, that has received a loan from a lender, or has applied for a loan from a lender (“potential borrower”). In some embodiments, the borrower can be a third party or parties, who guarantee or co-sign a loan. A borrower may be a lessee, or party where something of value is provided to the borrower in exchange for consideration, and in the present context, qualified attribute(s) play some role in the loan, lease, or other agreement.

“Borrower Status” means the personal situation that applies to a borrower, such as whether single, married, divorcing, moving residences, changing employment, etc. It is particularly relevant to loan security when Borrower Status is changing.

“Character” means, in the context of lending, the borrower's integrity or desire of the borrower to repay the loan. A traditional stand-in for the character of the borrower might be a credit score, such as a FICO score.

“Collateral” means the property (tangible or intangible) of a borrower under the control of a lender to satisfy a debt in the event of a default by the borrower. Collateral under control includes the ability to control, restrict, or prevent access to a qualified online account, qualified security authentication identification, or a qualified attribute. Collateral could include the borrower's pledge or assignment of copyright interests (and other intellectual property rights) in qualified content that the borrower has in photos, writings, drawings, videos, audio recordings, or other intellectual property, in their qualified online account, to secure timely repayment of the borrower's loan.

“Credentials” means the data and means used by a borrower to access their qualified online account, qualified attribute, or qualified security authentication identification; which might include in some combination: a username, login name, password, secret questions/answers used for authentication, usernames and password by use of proxy logins, authentication tokens, secret questions, password reset questions, authentication schemes such as OAuth and SecurID devices, a real name, email address, password, shared secret, a token (fixed or variable), biometric information, IP address, geo-location information, computer identification, browser cookies, pre-selected questions and answers, government information associated with the borrower, historical or geographical information associated with the user, notarized identification, or other identification means. The term, “credentials” and “set of credentials” are predominantly the same, unless the context is clear otherwise.

“Crowdsourced risk evaluation” means judging, evaluating, or underwriting the risk of a borrower to meet loan conditions, tasks traditionally performed by an employee or contractor, and here outsourced to a group of people or community, through an “open call” to a large group of people (a crowd). For example, a crowd can rate the likelihood of a borrower defaulting on a loan based on examining the borrower's Facebook profile, the borrower's social contacts, or other information, including the social graph of the borrower. Another example of crowdsourced risk evaluation might include using crowds to judge, evaluate, or underwrite, unstructured text entries (free text) in borrowers' loan applications as to the ability of the borrowers to meet loan conditions. Yet another example would be to use crowds to examine borrowers' profiles for stability factors and risky behaviors derived from borrowers' social graphs, photos, writings, drawings, videos, audio recordings, or other documentation.

“Default,” “borrower is in default,” “default conditions,” or “default of the loan conditions” means that the borrower has not complied with, or abided by, the loan conditions. A default might include an anticipatory default. An anticipatory default might be conditions that imply that a default is imminent, such as the borrower creating a new qualified online account and communicating that qualified online account information to social contacts.

“DMCA takedown notice,” or “Digital Millennium Copyright Act takedown notice,” means communication to the qualified online account service providers or qualified security authentication providers, to remove intellectual property from their computer systems that the lender (or its assignee or third party) has intellectual property rights to, and that the borrower no longer has rights to.

“Efficacy of notification of a borrower,” “efficacy of notification of the borrower,” or “efficacy of notification,” means the likelihood that the borrower will be effectively shamed or embarrassed by notification of default as their loan status, and thus more likely to timely repay the loan to avoid such shaming or embarrassment. Conversely, it is the probability that a borrower will be more likely to make timely repayment, because of the desire of the borrower to receive public praise of their non-default loan status. Borrowers that have stricter privacy settings associated with qualified attributes than others are more likely to care about notification of their loan status to their social contacts than others, and thus more likely to make timely repayment. Stricter privacy settings might include the use of private (non-public) groups, less than the average public information displayed to non-social contacts, etc.

“Enforced by communicating a DMCA takedown notice” means taking away or restricting access to intellectual property of the borrower by means of a DMCA takedown notice.

“Financial event,” “financial events,” or “financial event associated with the loan to the borrower,” means any event that relates to a loan, relates to another financial arrangement, or relates to a change in the status of the borrower that is related to the likelihood of the borrower, making timely repayment. Financial events include late or missed payments, defaults and violations of loan covenants, and violations of terms or conditions. Financial events also include such activities on a qualified online service as substantial behavioral changes, adding or removing a large number of social contacts, a major drop in use, a change in employment or address, a change in account credentials, the incorporation of apps designed to circumvent account or behavior monitoring, lifestyle changes, and unusual travel. A financial event might include loans changing status from default to non default, or vice versa.

“Fraud criteria” means metrics or standards that indicate that the borrower may be fraudulent, may be providing false or misleading information to the lenders, may not be a legitimate borrower, or that the borrower might attempt to defraud the lenders. Examples of metrics that potentially indicate fraud include a small number of social contacts, a large percentage of social contacts that are new social contacts, social contacts that do not have mutual rich interaction with the borrower, being part of a group of linked social contacts that is substantially isolated from the other members of a qualified online service, etc.

“Guarantee,” “loan guarantees,” “co-signers,” or “guarantee a loan,” means a promise from a social contact or third party to make timely repayments if the borrower does not make timely loan repayments. Guarantees might be partial or total guarantees of timely repayment.

“Intellectual property registry” means the U.S. Copyright Office, U.S. Patent and Trademark Office, U.K. Intellectual Property Office, Canadian Intellectual Property Office, or other similar registry of intellectual property.

“Lender” means an entity that advances money or gives credit to a borrower.

“Loan” means a money advance, line of credit, credit card, or other financial arrangement, where “money” is defined specifically herein, or billers who advance on services or utilities for which billing will occur later. For example, “loan” includes credit or debit card paid advances, or credit or debit card money advancements (e.g., Visa, American Express®, and PayPal). A “loan” also includes advances made by a payment service, which might be an electronic or wireless payment service, such as payments by phone, Radio Frequency Identification (RFID), FastTrak®, and similar services. A loan includes loan conditions.

“Loan application” means a document or the process that provides financial and other information about a borrower on which the lender bases their decision to lend. The loan application may be a document, which may be an electronic document, which the borrower completes with their identity (name, address, social security number, etc.), the amount of loan requested, their qualified attribute (qualified online account or qualified security authentication identification), the password or the credential to the qualified attribute, or access to the social graph of the borrower. The loan application also might ask the borrower for the identification of potential loan repayment coaches, the identification of qualified payment account(s) of which borrower has a relationship, as well as other underwriting related questions.

“Loan coach,” “loan coaches,” “loan repayment coach,” “loan repayment coaches,” or “loan coaches of the borrower,” means social contacts of the borrower that assist the borrower with strategies and tactics on methods to timely repay loans. The advice might be as simple as “do not spend unnecessary money” or “obtain a job.” Loan repayment coaches may, but not necessarily, guarantee the loan of the borrower. The borrower, the lender, or both parties, might select loan repayment coaches. Loan repayment coaches might also be underwritten on their ability to assist borrowers. The loan coach may communicate with the borrower for the purpose of encouraging timely repayment of a loan, or conformance to the loan agreement. Such communication may be in the form of questions, encouragement, suggestions, help, or any other type, or form, of communication. Loan coaching may or may not include communication between the lender and the coach. Loan coaching may or may not include training, templates, tools, questionnaires, reminders, off-line activities, and is not constrained by the activities, methods, and modes in this definition.

“Loan condition,” “loan terms,” “loan terms and conditions,” “conditions of loans,” or “set of loan conditions,” means the terms, conditions, covenants, and restrictions under which the lender loans money, grants credit, or advances funds to the borrower. Loan terms include repayment schedule, interest rate, default conditions, and the like. Loan conditions also may include loan covenants, such as: keeping an active bank or payment account, not changing their account information, not creating new qualified online accounts or qualified authentication identification, or keeping loan repayment coaches active. Loan conditions might include potential lender actions in case of a default.

“Loan status,” “status,” “repayment status,” or “status of the loan,” means, is the borrower in default, or not in default, of the loan conditions.

“Money” means items of value. Money, in this application, includes: legal currencies; virtual currencies, and virtual goods; hard assets, such as gold, stocks, bonds, and promissory notes; and any other asset. For example, Facebook Credits® can be loaned to borrowers. The same is true of virtual goods, such as those used in qualified online services, such as: Habbo Hotel, Playdom, Gaia Online, World of Warcraft, or similar such qualified online services. Such virtual goods include points, chips, or virtual money, such as might be used in a customer loyalty program, gaming (gambling), online games, virtual reality such as Second Life, simulations, travel incentives, or temporary ownership of an asset.

“Monitoring,” or “monitoring for a financial event,” means checking the terms and conditions of any loan, and its status, including observing if the loan is in default, or is not in default, as defined by the loan conditions. Monitoring might include checking entries in databases, looking for default conditions, such as non-payment, as well as anticipatory default conditions. Monitoring might be achieved by computer implemented methods or manual methods. A typical embodiment of monitoring for a financial event associated with the loan to the borrower is checking for the timely repayment of a loan.

“Notifying social contacts,” “notifying,” “notifying contacts,” “notify contacts,” “notification,” or “notify social contacts” means communicating loan status or loan conditions by qualified online accounts: emails, instant messages, blogs, chat, texting, messaging through Facebook, MySpace, Twitter, or another social network; or writing on, or posting to, a Facebook, MySpace, or another social network wall; creating a website; using messaging on external websites; using retargeting; using advertising; using newsfeeds; sending a request, phoning or texting the social contacts of the borrower with a message; communicating with an app; using an Application Program Interface (API), an http request, a web server, a Remote Procedure Call (RPC), a Uniform Data Packet request (UDP), a Representable State Transfer (REST), a Simple Object Access Protocol (SOAP), or similar protocols; etc. Communicating loan status or condition information, could include notifying social contacts of the borrower that the borrower is making payments as per loan conditions (i.e., praise), is in default (i.e., shame), is curing a default condition, etc. Notification could be done one time, periodically, or when the loan condition changes. Notification might include: the borrower being granted access to, or use of, a loan status widget or loan status badge, displaying their loan status; a borrower being granted access to a loan status club (“good loan repayment club”); the borrower repayment status, including number of timely loan payments made, being added to a leader board system.

“Obtaining access,” or “obtain access,” means the right of the lender to perform certain actions upon the qualified attribute of the borrower. Certain actions can include the ability or right to take control of the qualified attributes, or could be the ability to examine or read certain characteristics of the qualified attributes. Certain actions also can include the right to notify or the right to send notification to the social contacts of the borrower. Other actions could include the ability to read the social graph of the borrower. Obtaining access might be performed with the assistance of the qualified online account service provider or qualified security authentication provider.

“Online information repository” means information repositories such as Rapleaf®, [x+1], Demdex^{SM}, Omniture^{SM}, Coremetrics^{SM}, WebTrends®, NetInsights^{SM}, DoubleClick®, and others of similar nature. These information repositories contain behavioral data banks or databases of online behavior of borrowers. The underlying information is gathered by tracking, and other technologies. Data associated with the borrower from an online information repository may have records of home ownership, family income, marital status, and favorite restaurants, among other data items.

“Performing password changes,” or “perform password changes,” or “performing password changes to restrict access,” means changing the borrower's username, login name, password, secret questions/answers used for authentication, usernames, and password by use of proxy logins, authentication tokens, secret questions, password reset questions, authentication schemes such as OAuth and SecurID devices, technical countermeasures, etc. Performing password changes may also include hindering email recovery, changing an email account to that of the lenders, changing a secret question, etc.

“Processing loan payments from the borrower,” or “processing loan payments,” means distributing or transferring money paid by the borrower to the lender via a qualified payment account of the borrower.

“Providing a loan to a borrower,” “providing a loan,” “provides the loan,” “provide a loan,” or “provide a loan to the borrower,” means a lender, loaning money, granting credit, or advancing funds to a borrower or the like, subject to a set of loan conditions and potentially underwriting criteria. Providing a loan to a borrower could include incorporating a third-party who actually provides the loan. These third-parties could include social contacts of the borrower (peer-to-peer lending), loan brokers, loan originators, affiliates of the lender, or another third party who uses a lender's system. Providing a loan could include facilitating a loan. The third-party that provides the loan may, for example, set the conditions for the loan, including the loan underwriting criteria, the exact mechanics of when to take the collateral, how to “praise” or “shame,” when to get an assignment of qualified contents of a qualified attribute, and how to use the social graph of the borrower to underwrite the loan. Additionally, providing a loan might include providing more than one loan. Providing a loan might include communicating with a borrower, to establish between the lender's system (which could also be a third party) and the borrower, a loan subject to a set of loan conditions.

“Provides the loan proceeds” means funding the loan by transferring or sending the money derived from the borrower getting the loan. An example is the lender sending the money to the borrower (usually to their qualified payment account) after the borrower is granted the loan.

“Proxy account access information” means account information, such as a proxy login name, password, access to any secret questions used for authentication, etc., that is associated with, or representative of, the actual login and/or password of a qualified online account, or the use of alternative or substitute account access credentials or methods.

“Proxy login” means causing the borrower to authenticate into a proxy server instead of the qualified attribute directly, and that proxy server to authenticate into the qualified attribute. This allows the lender's system to change the password (i.e., perform password changes), or other account information, so that the borrower is unable to directly access the qualified attribute, but is forced to authenticate to the proxy server. The effect of a proxy login makes taking control of attributes upon default more secure in that the borrower is unable to get control of the attributes. By way of example, a borrower that uses Gmail can be made to login to another email system (instead of Gmail). This other email system actually logs into Gmail to receive and send the email of the borrower. This allows the lender's system to take control of the Gmail account and restrict access to all or part of the functionality provided. For example, by changing the Gmail password to a password unknown to the borrower, the borrower will only have access through the proxy login, which may allow the borrower to read their mail, but not send e-mails, or restrict access to the calendaring function within Gmail, etc.

“Public repayment promises” means the borrower communicating with their social contacts of borrower's desire, agreement, or promise to make timely repayment of the loan. Public promises have been shown to reduce loan delinquency.

“Qualified attribute,” “qualified online attribute,” or “qualified attribute of the borrower,” means the borrower's qualified online account(s), and/or qualified authentication identification(s). These terms could include multiple attributes.

“Qualified content,” “qualified content of the borrower,” “qualified content of the qualified online account,” or “qualified content of the qualified attribute,” means content that the borrower has copyright, trademark, trade dress rights, or is subject to other intellectual property rights of the borrower. The qualified content might be photos, writings, drawings, videos, audio recordings, or other intellectual property. This qualified content may be stored in a qualified online account or qualified attribute. Qualified content includes the entirety of online content created by and provided by the borrower on or in the qualified online account.

“Qualified online account,” “online account,” “social networking account,” or “social media accounts,” means repositories of the borrower's social contacts, such as: Facebook, LinkedIn, Flickr, Twitter, Myspace, Plaxo, Match.com, Second Life, World of Warcraft, Habbo Hotel, Playdom, Gaia Online, as well as other social networks. Email accounts, such as, Gmail or Yahoo Mail are also qualified online accounts. Additionally, qualified online accounts might include phones (or phone numbers), which might have an associated repository of social contacts, such as, phone numbers called or texted by the borrower or the phone numbers of those who called or texted the borrower. Qualified online accounts could even include instant messaging accounts, such as ICQ or AOL Instant Messenger. Online gaming accounts, including multiplayer games, online gambling, and online simulation environments are specifically included, as are accounts at dating services, product and company review sites, food and eating sharing sites, and health information sharing sites. Qualified online account also might include the combination of a borrower, a social network, data on the social network associated with the borrower, and the credentials of the borrower to access the said data. The qualified online account might contain qualified content of the borrower.

“Qualified online account service providers” means the entities that provide the qualified online accounts. Some examples are provided under the definition for “qualified online account” and elsewhere herein. Additional examples include the telecommunications providers, such as AT&T or Vonage®.

“Qualified payment account” means any account, network, system or other mechanism used to store, facilitate, or effect the transfer of money (e.g., for the advancement of a loan or effect payments of a loan), from one account to another. Examples of a qualified payment account includes a bank account, savings account, money market account, Facebook Credit account, Second Life bank account, PayPal account, Visa credit card account, a MasterCard credit card account, etc. Money between qualified payment accounts can be transferred by such methods as Automated Clearing House (ACH) network, Western Union®, Electronic Funds Transfer (EFT), check, etc.

“Qualified payment account provider” means any company that provides a qualified payment account. Examples of qualified online account providers include PayPal, Visa Inc., MasterCard Corporation, Automated Clearing House (ACH), Electronic Funds Transfer (EFT), Authorize.Net®, and Western Union, etc.

“Qualified security authentication identification,” “qualified authorization identification,” or “qualified security authentication ID,” means any protocols, codes, software, or other electronic mechanisms that are used to authenticate a borrower online or who identify the borrower. Examples of qualified security authentication identification include uniform resource locators (URLs) and extensible resource identifier (XRIs) for OpenID, extensible markup language (XML), security assertion markup language (SAML), protocols for JanRain, and tokens for open authorization (OAuth). Qualified security authentication identification might be thought of as a pointer to the repository of social contacts or as alternative authentication identification required to access a repository of social contacts including a qualified online account. An example of this is Facebook Connect, which can allow a borrower to access both Facebook and other social contact repositories.

“Qualified security authentication provider” is a service provider that provides qualified security authentication identification. An example of a qualified security authentication provider is an OpenID provider. Examples of qualified security authentication service providers include Google, Inc., AOL, Myspace, MyOpenID, Facebook Connect, and Verisign.

“Receiving a loan application,” or “receive a loan application,” means the lender receiving or processing a loan application from the borrower directly or indirectly through a third party. Such receiving may use electronic communication means, such as the Internet. It may or may not include applying underwriting criteria.

“Recommendations of social contacts of the borrower” means that one or more social contacts of the borrower recommend to the lender that the lender advance funds or lends money to the borrower. When social contacts of the borrower recommend the borrower for a loan, it is more likely that the borrower will feel social pressure to make timely repayments.

“Relying party” means any website that desires to verify a borrower's qualified security authentication identification via a qualified security authentication provider.

“Restricting access” means restricting or controlling the borrower's access to their qualified online accounts, qualified security authentication identification, or qualified attributes. The purpose of restricting access is to prevent the borrower from interfering with the lender's system taking control or obtaining access to a qualified attribute.

“Securing the loan,” or “secure a loan,” means the steps necessary for prohibiting a borrower from obtaining access or taking control of a qualified attribute. Securing can be thought of as the ability to deny access or control, or the ability to obtain a security interest as a precursor to deny access or control. Securing the loan can also be thought of as the online equivalent of “perfecting a loan,” obtaining a security interest, filing a security interest financing statement, pledging, pawning personal property, or assigning intellectual property subject to return.

“Security interest financing statement,” or “financing statement,” means a UCC-1 statement, or any other documents or actions that records, memorializes, or creates a security interest benefiting the lender. In “security interest financing statement for the qualified attribute,” the security or collateral is the qualified attribute. In a “security interest financing statement for qualified contents of the qualified attribute,” the security or collateral is the qualified content of the qualified attribute. This qualified content is the qualified content of the borrower in which the borrower has copyright, trademark, trade dress rights, or is subject to other intellectual property rights. The qualified content might be photos, writings, drawings, videos, audio recordings, or other intellectual property. This qualified content may be stored in a qualified online account or qualified attribute. Qualified content includes the entirety of online content created by and provided by the borrower on or in the qualified online account. The security statement is usually filed at the appropriate intellectual property registry.

“Service provider” means a qualified online account service provider or qualified security authentication provider.

“Shame or praise” means that borrowers might be more likely to make timely loan repayment as per loan condition if their social contacts are notified that the borrower is not following the loan conditions, or that the loan status is in default (i.e., shame). Additionally borrowers might be more likely to make timely loan repayment as per loan condition if their social contacts are notified that they are in compliance with the loan conditions, or that the loan is not in a status of default (i.e., praise).

“Social contacts,” “contacts,” “social contacts of the borrower,” or “contacts of the borrower,” means a group of individuals or legal entities who have accounts on a qualified online service, and who have individually chosen to be linked to all, or a subset of, the other linked users, by virtue of a shared interest or commonality of friendship, relationship, business association, or health status, and wherein all of the linked users have an account on one or more social network(s). Additionally social contacts are any person, company, or other entity that the borrower has a relationship with that are stored in the repository in the borrower's qualified online account. Social contacts are sometimes known as “friends” (in the case of Facebook), “network members” (in the case of LinkedIn), “email contacts” (in the case of email), “phone contacts” (in the case of phone calls), “buddies” or “contacts” (in the case of instant messaging), or other similar terms. Additionally, social contacts might be people or entities, called or texted by the borrower, or who call or text the borrower. Social contacts are components of a social graph of a borrower.

“Social Contact Credit Score” (SCC Score) means a metric analogous to credit scores or a FICO score in traditional underwriting environments. It is a proxy for the likelihood that an individual will meet the loan conditions. The Social Contact Credit Score is computed based on number of social contacts of the borrower, the frequency that the borrower communicates with their social contacts, the frequency that the social contacts communicate with the borrower, the richness of the communications with the social contacts, the social contact credit score of the social contacts, other characteristics of the borrower's social graph, etc. In general, the more social contacts the borrower has, the more likely the loan conditions will be met. In general, the more frequent a borrower communicates with their social contacts, the more likely the loan conditions will be met. In general, the more frequent social contacts communicate with the borrower, the more likely the loan conditions will be met. In general, the richer the media interchange between the borrower and their social contact the more likely the loan conditions will be met. The higher the social contact credit score, the more likely the loan conditions will be met.

“Social graph” mean the relationship mapping of the social contacts of the borrower, and how they are related. For example, in Facebook the Graph API can be used to extract the social graph of a borrower. Google, Inc. also has a Social Graph API. Some standards using social graphs include the XHTML Friends Network (XFN), and the Friend of a Friend (FOAF), markup languages. Part of the social graph of the borrower may include the social graphs of the social contacts of the borrower.

“Social network” means a collection of computers, users (e.g., borrowers), servers, and data storage, such that the borrowers via said computers access said data created by or referenced by other borrowers, using the servers in part to accomplish this access, wherein also the data is stored on some combination of the computers and servers, and wherein borrowers who have accounts on the social network access the stored information periodically or repetitively, and wherein the majority of the data is created by the borrowers. Social networks include but are not limited to the following generic and specific services: email, chat, SMS, texting, on-line games, multi-player on-line games, photo sharing, personal blogs, Facebook (www.facebook.com), LinkedIn (www.linkedin.com), glassdoor (www.glassdoor.com), zynga (www.zynga.com), MySpace (www.myspace.com), bebo (www.bebo.com), friendster (www.friendster.com), hi5 (www.hi5.com), orkut (www.orkut.com), perfspot (www.perfspot.com), zorpia (www.zorpia.com), netlog (www.netlog.com), habbo (www.habbo.com), adampash (www.adampash.com), smugmug (www.smugmug.com), flickr (www.flickr.com), picas sa (www.picassa.com), photobucket (www.photobucket.com), and google apps (www.google.com/apps).

“Stability factors derived from the social graph,” or “stability factors derived from the social graph of the borrower,” means changes to the employment, relationship, health, medical expenses, living situation, workplace friendships, or the like, of the borrower that impact on the borrower's ability to make timely loan repayments. An example of a negative employment stability factor might include self-removal from a group that is materially comprised of workplace social contacts, or the removal from workplace groups. An example of a negative relationship stability factor might include a separation, divorce, or extramarital affair. In some embodiments, an indication of separation, divorce, or extramarital affair may be determined by monitoring/reviewing messages from the borrower. An example of a negative health stability factor might include a new medical condition that affects cash flow generation of the borrower. An example of a negative medical expenses stability factor might include the presence or absence of medical expenses not covered by medical insurance. An example of a negative living situation stability factor might include reduction in community involvement (becoming a loner), un-friending, or a reduction in the number of social contacts of the borrower. An example of a negative workplace friendship stability factor might include un-friending, or a reduction in the number of social contacts within the workplace of the borrower. The more negative these stability factors are, the more likely the borrower will not make timely repayments. The converse is also true: the more positive these stability factors are, the more likely the borrower will make timely repayments. In this current embodiment, stability factors are calculated using the social graph, changes in the social graph, or other factors of the borrower.

“Taking control,” “take control,” “restricting access,” or “restrict access of a borrower,” means the power of the lender to take action, including the action to take care, custody, or control, of a qualified attribute of the borrower. It also might include taking an action upon a qualified attribute of the borrower, such as notification. For example, by taking control of a Facebook account, the borrower might: not be able to login to the account to access the account's content, not be able to access the account during certain hours, or have a limited time of access. Another example is when the lender takes control of an email account, the borrower might not be able to access their email, access their email settings, or send new emails. A further example might be restricting the borrower's access to their phone or phone number(s), including voice mails left on those phone numbers, or their ability to send or receive texts messages (SMS). “Taking control” or “restricting access” also applies to accounts, such as a borrower's qualified security authentication identification. Taking control could include transferring the qualified online account to the lender or another third party. Taking control may also include turning off the qualified attribute. Taking control might including turning off or restricting access to other property of the borrower that is not a qualified attribute including automobiles, boats, home appliances, telecommunication devices, address books, phone directories, cable television services, servers, local computers, Facebook Fan Pages, business email systems, vanity subdomain URLs (for example, Facebook.com/gkremen), Internet access, domain names, IP addresses, BGP-4 protocol lists, etc.

“Technical countermeasures” means measures used to prevent a borrower from restoring services that were lost, or might be lost, as a result of a lender enforcing rights, preserving rights, or enforcing terms of a loan, related to loan status or loan default. Such measures includes changes to the credentials of the borrower, changes to the online account data of the borrower, means to detect a borrower using a different name or different set of credentials to attempt to re-establish a similar service to that which was lost, blocked, restricted, changed, or prevented, monitoring user data of the borrower, monitoring communication between the borrower and the social contacts of the borrower, monitoring changes to the preselected group of users, and other technological means related to the borrower or the data of the borrower. “Technical countermeasures” include restricting the borrower from interfering with the lender obtaining access to a qualified attribute, or taking control of a qualified attribute. The purpose of technical countermeasures is to make it difficult for the borrower to regain control of a qualified attribute and thus evading the lender taking control of the qualified attribute. Technical countermeasures can include: changing the username, login name, password, secret questions and answers used for authentication of the borrower, usernames and password by use of proxy logins, authentication tokens, authentication schemes such as OAuth and SecurID devices, or similar authentication methods, by means of qualified online account service providers or qualified security authentication providers, at the lender's request in certain circumstances. Restriction may include more than access prohibition also the suspension, restriction, or deletion of a qualified online account or qualified security authentication identification. This may also include hindering email recovery, changing email accounts to that of the lenders, changing a secret question, and similar restrictions.

“Texts” or “text messages” means SMS or Short Message Service.

“Timely repayment of a loan,” or “timely loan repayments,” means the borrower abiding by or following the loan conditions. Alternatively, from the lender's perspective, timely repayment of a loan may also include repayment of a loan in a method that the net present value of all the payments from the borrower are maximized. Untimely repayment of a loan can be known as a delinquent loan. A very untimely repayment can lead to the lender charging off the loan or a “charge off.”

“Underwriting criteria,” or “underwriting standards,” or “applying underwriting criteria to the borrower,” means the criteria behind the analysis that a lender uses to assess the eligibility of a borrower to receive a loan, or to continue to receive a loan under certain loan conditions, such as payment terms, interest rate, credit limits, or the like. Underwriting criteria includes assessing information on the credit worthiness of the borrower, or analyzing credit risk. It may be based on the borrower's FICO score, the borrower's Social Contact Credit Score, recommendations of social contacts, co-signing or guarantees by social contacts, and any other criteria used to assess the eligibility of a borrower to receive a loan or meet loan conditions. Underwriting might be done by a third-party or using a third party's criteria. In general, underwriting criteria are items that imply the propensity of the borrower to not default on a loan. This may also be known as “underwriting a borrower.”

It is to be understood that the disclosure teaches examples of the illustrative embodiments and that many variations of the invention can easily be devised by those skilled in the art after reading this disclosure and that the scope of the present invention is to be determined by the claims below.

1. A computer implemented method for increasing the likelihood of timely repayment of a loan, the method comprising:
obtaining access to a qualified attribute of a borrower by a first computer component;
monitoring, by a second computer component, for a financial event associated with the loan to the borrower; and
taking control of the qualified attribute of the borrower by a third computer component upon detection of the financial event.

2. The computer implemented method of claim 1, further comprising securing the loan against the qualified attribute of the borrower.

3. The computer implemented method of claim 2, wherein securing the loan includes filing a security interest financing statement for the qualified attribute of the borrower.

4. The computer implemented method of claim 2, wherein securing the loan includes filing a security interest financing statement for qualified contents of the qualified attribute of the borrower.

5. The computer implemented method of claim 2, wherein securing the loan includes assigning, to a lender or third-party service provider, qualified contents of the qualified attribute of the borrower.

6. The computer implemented method of claim 5, wherein assigning of the qualified contents of the borrower includes enforcing by communicating a DMCA takedown notice upon detection of the financial event.

7. The computer implemented method of claim 1, wherein the step of taking control by the third computer component includes taking technical countermeasures.

8. The computer implemented method of claim 7, wherein taking technical countermeasures includes restricting access of the borrower to the qualified attribute of the borrower.

9. The computer implemented method of claim 7, wherein taking technical countermeasures includes performing password changes to restrict access of the borrower to the qualified attribute of the borrower.

10. The computer implemented method of claim 7, further comprising instituting a proxy login via a proxy server for the borrower to access the qualified attribute of the borrower.

11. The computer implemented method of claim 1, wherein the financial event includes a loan status that the borrower is in default of one or more loan conditions.

12. The computer implemented method of claim 1, wherein the financial event includes a change of borrower status.

13. The computer implemented method of claim 1, further comprising applying underwriting criteria to the borrower to achieve a result.

14. The computer implemented method of claim 13, further comprising denying the loan based on the result of applying the underwriting criteria to the borrower.

15. The computer implemented method of claim 13, further comprising approving the loan based on the result of applying the underwriting criteria to the borrower.

16. The computer implemented method of claim 1, further comprising providing the loan to the borrower.

17. The computer implemented method of claim 16, wherein providing the loan to the borrower includes providing loan proceeds via a qualified payment account of the borrower.

18. The computer implemented method of claim 1, further comprising receiving a loan application from the borrower.

19. The computer implemented method of claim 1, further comprising processing loan payments from the borrower via a qualified payment account of the borrower.

20. The computer implemented method of claim 1, wherein taking control includes notifying at least one social contact of the borrower.

21. The computer implemented method of claim 13, wherein applying the underwriting criteria includes considering the efficacy of notification of the borrower.

22. The computer implemented method of claim 1, wherein at least some acts of the method are performed by a lender involved in the loan.

23. The computer implemented method of claim 1, wherein at least some acts of the method are performed under control of a third-party service provider engaged by a lender involved in the loan.

24. The computer implemented method of claim 23, wherein at least some acts of the method are performed by the lender.

25. The computer implemented method of claim 1, wherein the second computer component monitors for a plurality of financial events, and taking control includes various actions that depend upon a type of the financial event detected.

26. The computer implemented method of claim 1, wherein the financial event includes a substantial behavior change of the borrower.

27. The computer implemented method of claim 26, wherein the substantial behavior change includes removing social contacts associated with a current employer of the borrower from the qualified attribute of the borrower.

28. The computer implemented method of claim 26, wherein the substantial behavior change includes a major drop in use of a qualified online service.

29. The computer implemented method of claim 26, wherein the substantial behavior change includes an incorporation of the borrower of apps designed to circumvent account or behavior monitoring.

30. The computer implemented method of claim 26, wherein the substantial behavior change includes lifestyle changes or unusual travel.

31. The computer implemented method of claim 26, wherein the substantial behavior change includes a change in a stability factor.

32. The computer implemented method of claim 31, wherein the borrower is married and the stability factor includes an evaluation of infidelity based on messaging between the married borrower and a non-spouse individual.

33. A system for increasing the likelihood of timely repayment of a loan, the system comprising:
a network interface;
a processor; and
a memory, wherein the memory is configured with instructions which, when executed, cause the processor to:
obtain access, via the network interface, to a qualified attribute of a borrower;
monitor, via the network interface, for a financial event associated with the loan to the borrower; and
take control, via the network interface, of the qualified attribute of the borrower upon detection of the financial event.

34. The system of claim 33, wherein the memory is configured with further instructions which, when executed, cause the processor to initiate a process to secure the loan against the qualified attribute of the borrower.

35. The system of claim 34, wherein securing the loan by the processor includes filing a security interest financing statement for the qualified attribute of the borrower.

36. The system of claim 34, wherein securing the loan by the processor includes filing a security interest financing statement for qualified contents of the qualified attribute of the borrower.

37. The system of claim 34, wherein securing the loan by the processor includes assigning to a lender, qualified contents of the qualified attribute of the borrower.

38. The system of claim 37, wherein assigning of the qualified contents of the qualified attribute of the borrower by the processor includes enforcement by communicating a DMCA takedown notice upon detection of the financial event.

39. The system of claim 33, wherein the memory is configured with further instructions which, when executed, cause the processor to take control, including taking technical countermeasures.

40. The system of claim 39, wherein taking technical countermeasures includes restricting access of the borrower to the qualified attribute of the borrower.

41. The system of claim 39, wherein taking technical countermeasures by the processor includes performing password changes to restrict access of the borrower to the qualified attribute of the borrower.

42. The system of claim 39, wherein the memory is configured with further instructions which, when executed, cause the processor to institute, via the network interface, a proxy login via a proxy server for the borrower to access the qualified attribute of the borrower.

43. The system of claim 33, wherein the financial event includes a loan status that the borrower is in default of one or more loan conditions.

44. The system of claim 33, wherein the financial event includes a change of borrower status.

45. The system of claim 33, wherein the memory is configured with further instructions which, when executed, cause the processor to initiate a process, via the network interface, for applying underwriting criteria to the borrower to achieve a result.

46. The system of claim 45, wherein the memory is configured with further instructions which, when executed, cause the processor to initiate a process for denying the loan based on the result of applying underwriting criteria to the borrower.

47. The system of claim 45, wherein the memory is configured with further instructions which, when executed, cause the processor to initiate a process for approving the loan based on the result of applying underwriting criteria to the borrower.

48. The system of claim 33, wherein the memory is configured with further instructions which, when executed, cause the processor to initiate a process to provide, via the network interface, the loan to the borrower.

49. The system of claim 48, wherein providing the loan by the processor includes providing the loan proceeds via a qualified payment account of the borrower.

50. The system of claim 33, wherein the memory is configured with further instructions which, when executed, cause the processor to receive, via the network interface, a loan application from the borrower.

51. The system of claim 33, wherein the memory is configured with further instructions which, when executed, cause the processor to process, via the network interface, loan payments from the borrower via a qualified payment account of the borrower.

52. The system of claim 33, wherein taking control by the processor includes notifying, via the network interface, at least one social contact of the borrower a loan status of the borrower.

53. The system of claim 45, wherein applying the underwriting criteria by the processor includes considering the efficacy of notification of the borrower.

54. The system of claim 33, wherein the system is a lender's computer system.

55. The system of claim 33, wherein the system is a third-party service provider's computer system, and the third-party service provider is engaged by a lender in connection with the loan.

56. The system of claim 33, wherein the system is a distributed system and one or both of the memory and the processor can each be multiple distinct devices located on separate computer systems.

57. The system of claim 33, wherein the system monitors via the network interface for a plurality of financial events, and taking control includes various actions that depend upon a type of the financial event detected.

58. The system of claim 33, wherein the financial event includes a substantial behavior change of the borrower.

59. The system of claim 58, wherein the substantial behavior change includes removing social contacts associated with a current employer of the borrower from the qualified attribute of the borrower.

60. The system of claim 58, wherein the substantial behavior change includes a major drop in use of a qualified online service.

61. The system of claim 58, wherein the substantial behavior change includes an incorporation of the borrower of apps designed to circumvent account or behavior monitoring.

62. The system of claim 58, wherein the substantial behavior change includes lifestyle changes or unusual travel.

63. The system of claim 58, wherein the substantial behavior change includes a change in a stability factor.

64. The system of claim 63, wherein the borrower is married and the stability factor includes an evaluation of infidelity based on messaging between the married borrower and a non-spouse individual.

65. A computer implemented method for increasing the likelihood of timely repayment of a loan, the method comprising:
obtaining access to a Facebook account of a borrower on the loan by a first computer component;
monitoring by a second computer component for a financial event associated with the loan to the borrower; and
taking control of the Facebook account of the borrower by a third computer component upon detection of the financial event, including notifying at least one friend of the borrower of a loan status of the borrower.

66. The computer implemented method of claim 65, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

67. A system for increasing the likelihood of timely repayment of a loan, the system comprising:
a network interface;
a processor; and
a memory, wherein the memory is configured with instructions which, when executed, cause the processor to:
obtain access, via the network interface, to a Facebook account of a borrower on the loan;
monitor, via the network interface, for a financial event associated with the loan to the borrower; and
take control, via the network interface, of the Facebook account of the borrower upon detection of the financial event, including notifying at least one friend of the borrower of a loan status of the borrower.

68. The system of claim 67, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

69. A computer implemented method for increasing the likelihood of timely repayment of a loan by a borrower, the method comprising:
obtaining access to an email account of the borrower by a first computer component;
monitoring by a second computer component for a financial event associated with the loan to the borrower; and
taking control of the email account of the borrower by a third computer component upon detection of the financial event, wherein taking control includes changing the password of the email account of the borrower.

70. The computer implemented method of claim 69, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

71. A system for increasing the likelihood of timely repayment of a loan by a borrower, the system comprising:
a network interface;
a processor; and
a memory, wherein the memory is configured with instructions which, when executed, cause the processor to:
obtain access, via the network interface, to an email account of the borrower;
monitor, via the network interface, for a financial event associated with the loan to the borrower; and
take control, via the network interface, of the email account of the borrower upon detection of the financial event, wherein to take control includes changing the password of the email account of the borrower.

72. The system of claim 71, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

73. A computer implemented method for increasing the likelihood of timely repayment of a loan by a borrower, the method comprising:
obtaining access to a Facebook account of the borrower by a first computer component;
monitoring by a second computer component for a financial event associated with the loan to the borrower; and
taking control of the Facebook account of the borrower by a third computer component upon detection of the financial event, wherein taking control includes assigning qualified content of the Facebook account of the borrower to the lender.

74. The computer implemented method of claim 73, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

75. A system for increasing the likelihood of timely repayment of a loan by a borrower, the system comprising:
a network interface;
a processor; and
a memory, wherein the memory is configured with instructions which, when executed, cause the processor to:
obtain access, via the network interface, to a Facebook account of the borrower;
monitor, via the network interface, for a financial event associated with the loan to the borrower; and
take control, via the network interface, of the Facebook account of the borrower upon detection of the financial event, wherein to take control includes assigning qualified content of the Facebook account of the borrower to the lender.

76. The system of claim 75, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

77. A computer implemented method for increasing the likelihood of timely repayment of a loan by a borrower, the method comprising:
obtaining access to a Facebook account of the borrower by a first computer component;
monitoring by a second computer component for a financial event associated with the loan to the borrower;
taking control of the Facebook account of the borrower by a third computer component upon detection of the financial event, wherein taking control includes assigning qualified content of the Facebook account of the borrower to the lender; and
enforcing the assignment by communicating a DMCA takedown notice upon detection of the financial event.

78. The computer implemented method of claim 77, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

79. A system for increasing the likelihood of timely repayment of a loan by a borrower, the system comprising:
a network interface;
a processor; and
a memory, wherein the memory is configured with instructions which, when executed, cause the processor to:
obtain access, via the network interface, to a Facebook account of the borrower by a first computer component;
monitor, via the network interface, for a financial event associated with the loan to the borrower;
take control, via the network interface, of the Facebook account of the borrower upon detection of the financial event, wherein to take control includes assigning qualified content of the Facebook account of the borrower to the lender; and
enforce the assignment by communicating a DMCA takedown notice upon detection of the financial event.

80. The system of claim 79, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

81. A computer implemented method for increasing the likelihood of timely repayment of a loan, the method comprising:
obtaining access to a Facebook account of a borrower on the loan by a first computer component;
monitoring by a second computer component for a financial event associated with the loan to the borrower; and
notifying social contacts of the Facebook account of the borrower by a third computer component upon detection of the financial event, whereby notifying social contacts includes notifying by a Facebook message, creating a Facebook event, or posting on a Facebook wall of the borrower.

82. The computer implemented method of claim 81, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

83. A system for increasing the likelihood of timely repayment of a loan, the system comprising:
a network interface;
a processor; and
a memory, wherein the memory is configured with instructions which, when executed, cause the processor to:
obtain, via the network interface, access to a Facebook account of a borrower on the loan;
monitor, via the network interface, for a financial event associated with the loan to the borrower; and
notify, via the network interface, social contacts of the Facebook account of the borrower upon detection of the financial event, whereby to notify social contacts includes notifying by a Facebook message, creating a Facebook event, or posting on a Facebook wall of the borrower.

84. The system of claim 83, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

85. A computer implemented method for increasing the likelihood of timely repayment of a loan, the method comprising:
obtaining access to a Facebook account of a borrower on the loan by a first computer component;
applying underwriting criteria including requiring the borrower to take on a loan repayment coach by a second computer component;
monitoring by a third computer component for a financial event associated with the loan to the borrower; and
notifying the loan repayment coach by a fourth computer component upon detection of the financial event.

86. The computer implemented method of claim 85, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

87. A system for increasing the likelihood of timely repayment of a loan, the system comprising:
a network interface;
a processor; and
a memory, wherein the memory is configured with instructions which, when executed, cause the processor to:
obtain access, via the network interface, to a Facebook account of a borrower on the loan;
apply underwriting criteria, using the processor, including requiring the borrower to take on a loan repayment coach;
monitor, via the network interface, for a financial event associated with the loan to the borrower; and
notify, via the network interface, the loan repayment coach upon detection of the financial event.

88. The system of claim 87, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

89. A computer implemented method for increasing the likelihood of timely repayment of a loan, the method comprising:
obtaining access to a Facebook account of a borrower on the loan by a first computer component;
applying underwriting criteria including requiring the borrower to take on a loan repayment coach by a second computer component;
monitoring by a third computer component for a financial event associated with the loan to the borrower; and
notifying the borrower of comments of the loan repayment coaches by a fourth computer component upon detection of the financial event.

90. The computer implemented method of claim 89, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.

91. A system for increasing the likelihood of timely repayment of a loan, the system comprising:
a network interface;
a processor; and
a memory, wherein the memory is configured with instructions which, when executed, cause the processor to:
obtain access, via the network interface, to a Facebook account of a borrower of the loan;
apply underwriting criteria, using the processor, including requiring the borrower to take on a loan repayment coach;
monitor, via the network interface, for a financial event associated with the loan to the borrower; and
notify, via the network interface, the borrower of comments of the loan repayment coaches upon detection of the financial event.

92. The system of claim 91, wherein the financial event includes a default, substantial behavioral changes, adding or removing a large number of social contacts, a major drop in use, a change in employment or address, a change in account credentials, the incorporation of apps designed to circumvent account or behavior monitoring, lifestyle changes, or unusual travel.
